(19) United States
(12) Patent Application Publication
(10) Pub. No.: US 2026/0144301 A1
(43) Pub. Date: May 28, 2026

(54) VAPORIZING DEVICE

(71) Applicant: Noah Mark MINSKOFF, Boise, ID (US)

(72) Inventor: Noah Mark MINSKOFF, Boise, ID (US)

(21) Appl. No.: 19/455,300

(22) Filed: Jan. 21, 2026

Related U.S. Application Data
(63) Continuation of application No. PCT/US24/40704, filed on Aug. 2, 2024.
(60) Provisional application No. 63/530,582, filed on Aug. 3, 2023.
(60) Provisional application No. 63/566,372, filed on Mar. 17, 2024.
(60) Provisional application No. 63/566,336, filed on Mar. 17, 2024.

(51) Int. Cl. A24F 40/48; A24F 40/10; A24F 40/42; A24F 40/46; A24F 40/51; A24F 40/57; H05B 3/00; H05B 3/22

(52) U.S. Cl. CPC A24F 40/48; A24F 40/10; A24F 40/42; A24F 40/46; A24F 40/51; A24F 40/57; H05B 3/0071; H05B 3/22

(57) ABSTRACT

A vaporizer device that utilizes suction to draw gas into the device and percolate the gas through a liquid contained within the device. The gas may be then directed through a chamber assembly equipped with a heat source, which vaporizes precursor composition held in a reservoir. The chamber assembly incorporates features to induce a rotational flow path, enhancing the mixing and aerosolization of the precursor compounds and selectively removing particles from an aerosol by modifying velocity and pressure of the flow. A heat exchanger system is included within the liquid container to ensure efficient thermal regulation of the aerosol before the aerosol may be inhaled. This abstract provides an introduction to the concepts disclosed herein and should not be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure may be not limited to the implementations disclosed herein. On the contrary, the intent may be to cover all alternatives, modifications, and equivalents.

FIG. 1 is a block diagram illustrating a vaporing device.

FIG. 2 is a block diagram illustrating a vaporing device.

FIG. 3A illustrates an isometric view of a heat exchanger.

FIG. 3B illustrates a top view of a heat exchanger.

FIG. 4A illustrates an intake for a vaporizing device.

FIG. 4B illustrates an intake in relation to a cannister for a vaporizing device.

FIG. 5A illustrates a cannister assembly for a vaporizing device.

FIG. 5B illustrates a cross-section of a cannister assembly for a vaporizing device.

FIG. 6A illustrates a chamber assembly for a vaporizing device.

FIG. 6B illustrates an exploded view of a flow assembly for a vaporizing device.

FIG. 6C illustrates an exploded view of a flow control for a vaporizing device.

FIG. 6D illustrates an isometric view of a flow director for a vaporizing device.

FIG. 6E illustrate a side view of a flow director for a vaporizing device.

FIG. 6F illustrates a cross-section of a chamber sub-assembly for a vaporizing device.

FIG. 6G illustrates a reservoir assembly for a vaporizing device.

FIG. 6H illustrates a cross-section of a chamber assembly for a vaporizing device.

FIG. 7A illustrates an isometric view of a vaporizing device.

FIG. 7B illustrates a cross-section a vaporizing device.

FIG. 8 illustrates a vaporizing device.

### DETAILED DESCRIPTION

Vaporizers have become increasingly popular for the consumption of various precursor compositions, particularly those derived from cannabis and tobacco. These devices offer a smokeless alternative to traditional smoking methods, potentially reducing harmful byproducts and providing a more controlled delivery of active compounds.

Vaporizers may rely on heating elements to directly vaporize the precursor composition, which may sometimes lead to uneven heating and inconsistent vapor quality. Moreover, these devices may result in dry or harsh vapor that can be uncomfortable for users. Additionally, vaporizers may not efficiently separate unwanted particles from the aerosol, potentially affecting the purity and taste of the inhaled product.

A device utilizes suction to draw gas into the vaporizer and percolate gas through a liquid. This process conditions the gas by filtering out particles, humidifying the gas, and normalizing the temperature of the gas. The conditioned gas may be then directed through a chamber assembly equipped with a heat source, which vaporizes the precursor composition held in a reservoir. The chamber assembly includes features to induce a rotational flow path, enhancing the mixing and aerosolization of the precursor compounds and selectively removes particles from an aerosol by modifying velocity and pressure of the flow. The invention also incorporates a heat exchanger system within the liquid container, ensuring efficient thermal regulation of the aerosol before the aerosol may be inhaled. This may result in a high-quality, smooth, and consistent inhalation aerosol, providing an improved user experience.

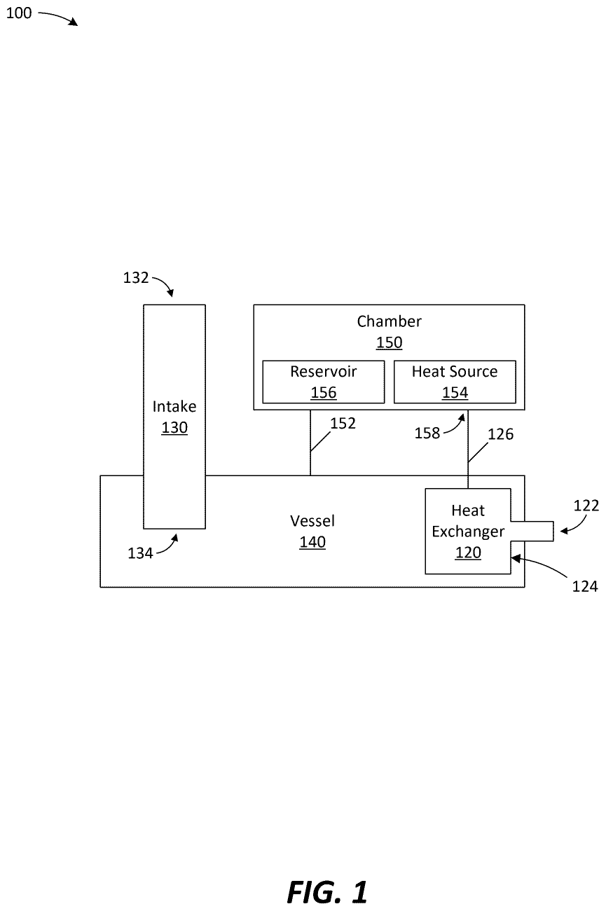

FIG. 1 is a block diagram illustrating a vaporing device. In FIG. 1, vaporizing device 100 comprises heat exchanger 120, intake 130, vessel 140, and chamber 150. Vaporizing device 100 may utilizes suction (e.g., from a user) to generate a flow within vaporizing device 100.

Heat exchanger 120 may be configured to normalize a temperature difference between an aerosol (or vapor) passing through heat exchanger 120 and a liquid exterior to heat exchanger 120. In an embodiment, heat exchanger 120 functions similarly to a surface condenser, where the vapor may be physically separated from the cooling liquid. Examples of such condensers include the Liebig, Graham, Allihn, Dimroth, and Friedrichs condensers.

Heat exchanger 120 includes first end 122 configured to receive suction and deliver an aerosol to a user. In an embodiment, first end 122 may comprise a mouthpiece. In an embodiment, first end 122 may be configured to couple to a mouthpiece. In an embodiment, first end 122 may be configured to couple to a positionable mouthpiece where the ability to position the mouthpiece may be due to a ball and socket type of sealed joint arrangement.

Wall 124 forms a passageway between first end 122 and second end 126 and physically separates an aerosol traveling between second end 126 and first end 122 from a liquid contained by vessel 140. Second end 126 may be configured to receive an aerosol and deliver suction to chamber 150. In an embodiment, wall 124 comprises a tube formed into a coil having a consistent inner diameter allowing for laminar flow, thereby reducing undesired impaction of aerosol particles with wall 124. In an embodiment, wall 124 may be or comprise a tube having a consistent inner diameter to encourage laminar flow of an aerosol through heat exchanger 120 and to reduce the undesired impaction of aerosol particles with the interior of wall 124.

Heat exchanger 120 may be contained within vessel 140. Wall 124 of heat exchanger 120 may be submerged in a liquid contained by vessel 140. The liquid contained by vessel 140 may be in thermal communication with wall 124. Walls 124 will seek to be in thermal communication with the liquid contained by vessel 140. Vaporizing device 100 includes intake 130. Intake 130 delivers a gas to a liquid contained by vessel 140 and creates a turbulent flow of liquid around wall 124 thereby improving heat transfer between wall 124 and the liquid. In an embodiment the liquid may serve to cool heat exchanger 120. In an embodiment, a liquid may serve to warm heat exchanger 120. In an embodiment, a liquid may maintain heat exchanger 120 temperature at ambient. In an embodiment, a liquid may maintain the condenser temperature at human physiological temperature (approximately 99 Degrees). In an embodiment, the liquid may be water.

In operation, suction may be applied to first end 122 to create a flow through vaporizing device 100. The suction may draw an aerosol from chamber 150 into heat exchanger 120 via second end 126 of heat exchanger 120. The aerosol may be thermally mediated as it travels through heat exchanger 120. The aerosol seeks to reach thermal equilibrium with wall 124 as it travels through heat exchanger 120. Wall 124 seeks to be in thermal equilibrium with a liquid moving around wall 124. A dynamic flow of a liquid occurring exterior to heat exchanger 120 may improve heat transfer of the liquid and wall 124 of heat exchanger 120. First end 122 may then deliver an aerosol to a user.

Vaporizing device 100 includes intake 130 to deliver a gas to vessel 140. Intake 130 comprises first end 132 and second end 134. First end 132 and second end 134 are connected via a passageway. First end 132 may be configured to receive a flow of gas exterior to vessel 140. In an embodiment, the gas comprises air at atmospheric pressure. In an embodiment, the gas may be above atmospheric pressure. In an embodiment, first end 132 may include a user adjustable intake gas flow port that allows for a user to control an intake gas volume and velocity entering the liquid medium. Control over a dynamic flow state (degree of percolation) of a liquid volume may be by selective control of the volume and velocity of intake gas moving through the liquid column.

Second end 134 may be configured to deliver a flow of intake gas below a surface of a liquid contained by vessel 140. In an embodiment, second end 134 may include a plurality of radially disposed ports configured to deliver a gas to vessel 140. In an embodiment, second end 134 may include ports set at an angle normal to that of an intake gas flow, and the angle of attack of the intake gas on the ports may be subsequently normal to, or 90 degrees to, that of the intake gas stream entering and initially passing into a liquid volume.

The delivery of gas into a liquid contained by vessel 140 creates a dynamic flow state or turbulence within the liquid. This dynamic flow of liquid around wall 124 of heat exchanger 120 may improve heat transfer between the liquid and heat exchanger 120. In an embodiment, second end 134 may transition a laminar flow of gas received from first end 132 to a turbulent flow in a liquid volume. This conversion from linear to turbulent flow may increase the dwell time of a gas within a liquid column contained by vessel 140. This dwell time may be generally described as the transit time through the liquid. Increasing the transit time of a gas flow through a liquid may enhance comixing the gas and liquid and allow more time for the gas to reach thermal equilibrium with the liquid.

Intake 130 may be coupled to vessel 140. In an embodiment, intake 130 may be integral with vessel 140. In an embodiment, intake 130 may be mechanically coupled to vessel 140. Intake 130 may be mechanically coupled to vessel 140 via threads, welds, adhesives, etc. Intake 130 may be mechanically coupled to vessel 140 by friction from a gasket or seal in communication with vessel 140.

Vessel 140 may be configured to contain fluids. Vessel 140 may contain a fluid or fluids in a liquid state and a fluid or fluids in a gas state. A gas may be delivered by second end 134 of intake 130 beneath a surface of a liquid contained by vessel 140. The gas may percolate through the liquid to generate a conditioned gas. This percolation may comix the gas with the liquid to adjust a humidity level and a temperature of the gas thereby generating a conditioned gas. In addition, this percolation may create a dynamic flow of liquid around heat exchanger 120. In an embodiment, the liquid may be or comprise water. In an embodiment, the liquid may be or comprise a humectant to control moisture content and degree of saturation of a conditioned gas generated by vessel 140. Examples of humectants may include vegetable-based glycerol, adulterated glycerol, glycol, and adulterated glycol.

Vessel 140 may contain heat exchanger 120 in communication with fluids contained by vessel 140. Heat exchanger 120 may be positioned within vessel 140 to partially obstruct a flow of gas delivered into vessel 140 by intake 130. In this configuration, heat exchanger 120 may help to increase the dwell time and the flow path of a gas percolating through the liquid. In addition, locating heat exchanger 120 in the flow path of a gas through a liquid contained by vessel 140 may improve heat transfer between the liquid and heat exchanger 120 as the flow of gas creates a dynamic flow of liquid around wall 124.

Chamber 150 may be configured to generate an aerosol by vaporizing and/or entraining a precursor composition into a flow of gas. Chamber 150 includes first end 152 to receive a flow of conditioned gas from vessel 140 and deliver the flow of conditioned gas near a precursor composition held by reservoir 156. In an embodiment, first end 152 may include internal geometry configured to encourage a laminar flow of a gas. In an embodiment, first end 152 may include internal geometry to modify the velocity and pressure of a flow of gas. In an embodiment, first end 152 may include an adjustable port to allow a user to mix a gas exterior to chamber 150 with a flow of conditioned gas received from vessel 140.

Chamber 150 may include a plurality of radially distributed helical ports to deliver a vortical laminar flow of gas near a precursor composition held by reservoir 156. The vortical flow includes higher velocities of flow being concentrated most radial within chamber 150 as defined by v=rω where the velocity may be directly proportional to the radial distance and therefore lower velocities are most axial and higher velocities are most circumferential. This vortical flow may select for particle size based on corresponding particle mass as the particles moving in a rotational flow are subjected to centrifugal forces where F=mv²/r, and the force may be directly proportional to the mass. This increases the transit time of larger particles withing the rotational flow. Smaller particles may escape the rotational radial flow by moving to the axial center of the flow to be entrained in a flow of aerosol to be delivered from chamber 150.

Chamber 150 includes reservoir 156. Reservoir 156 may hold a precursor composition in relation to heat source 154. Reservoir 156 comprises a cylinder having a closed bottom and an open top. In an embodiment, the bottom of reservoir 156 may be closed in such a fashion as to provide a conical structure axial to the cylinder body. This conical structure may increase the surface area of a closed cylinder where A=πr(r+√(h²+r²) for a circular right cone and A=πr² for the closed area of a standard cylinder. This conical structure may encourage and maintain a vorticial flow of gas within reservoir 156. The combination of an increase in surface area by a cylindrical bottom of reservoir 156 and a vortical flow of gas around a precursor composition held by reservoir 156 may maximize the available surface area of reservoir 156 in thermal communication with a precursor composition having not phase changed or aerosolized. Precursor composition material that has been phase changed or transitioned to an aerosol may escape reservoir 156 via particle size and mass mediated entrainment into an escaping aerosol stream out of reservoir 156 and chamber 150. In an embodiment, reservoir 156 may be or comprise glass (e.g., borosilicate glass, fused silica, fused Quartz, etc.) thereby permitting transmission of infrared radiation through reservoir 156 to heat a precursor composition held by reservoir 156.

Chamber 150 includes heating source 154 to heat a precursor composition to a predetermined temperature. Heat source 154 may be located in proximity to reservoir 156 within chamber 150. Heat source 154 may be configured to convert electrical energy to thermal energy. Heat source 154 may function to heat flowing gas and/or vapor in the vicinity of heat source 154 without directly contacting the air and/or vapor. In an embodiment, heat source 154 may be a source of infrared radiation. Heat source 154 may provide infrared radiation to a precursor composition held by reservoir 156 to permit the thermal mobilization (i.e., phase change or aerosolization) of constitutes comprising the precursor composition.

In an embodiment, heat source 154 may be or comprise a resistive element. In an embodiment, heat source 154 may be or comprise a coil of wire. In an embodiment, heat source 154 may be or comprise wire formed into a conical spiral. In an embodiment, Heat source 154 may be glass encapsulated and has a gas filled, sealed vessel with a filament, resistant element, or diode encased therein and two or more points to establish electrical contact with said filament, resistant element, or diode. In an embodiment, heat source 154 may be glass encapsulated and has a gas filled, sealed vessel with a filament, resistant element, or diode that emits visible light. In an embodiment, Heat source 154 may be glass encapsulated and has a gas filled, sealed vessel with a filament, resistant element, or diode that emits non-visible light in the infrared wavelengths. In an embodiment, Heat source 154 may be an inductive heater. In an embodiment, Heat source 154 may be or comprise stainless steel. In an embodiment, Heat source 154 may be or comprise steel, aluminum, iron-chromium-aluminum alloys, titanium, nickel, copper, tungsten, nickel-chromium alloy, carbon, silicon carbide, or other materials capable of converting electrical energy into thermal energy. In an embodiment, heat source 154 may be configured to heat a precursor composition to a desired temperature range from 320F-700F. In an embodiment, reservoir 156 may be coupled to heat source 154 to deliver thermal energy to a precursor composition via conduction.

In an embodiment, chamber 150 may include a reflector shaped or composed to focus or direct infrared radiation generated by heat source 154 on a specific target, volume, area, or substance (e.g., a precursor composition). In an embodiment, the reflector may be or comprise aluminum. In an embodiment, the reflector may be or comprise silver, stainless steel, coated polyester film, metalized film, or some other material capable of reflecting infrared radiation.

This method for thermally mediated particle formation couples the characteristics of rotational flow mass effects and the delivery of the requisite thermal energy needed to reduce the particle size of phase changed or aerosolized precursor composition sufficiently to escape reservoir 156 and functionally serves to keep portions of precursor composition having not phase changed or been transitioned into an aerosol in the region of reservoir 156 most proximal to heating source 154. The vortical flow of a gas around a precursor composition held by reservoir 156 in combination with the application of heat provided by heat source 154 within chamber 150 may create a region of a comparatively high velocity, high pressure flow. This high velocity, high pressure vortical flow may reduce the thermal energy required to affect a phase change or transition to aerosol of the precursor composition by increasing the transit time based on mass, maximizing dynamic flow mediated exposure to heated region of chamber 150, and dynamic mixing or mobilization of the material mitigating static exposure to heat source 154.

Chamber 150 includes second end 158. Second end 158 may include airflow features for control over velocity and pressure gradients for particle normalization of the generated aerosol. Second end 158 may include regions of constriction and expansion that may alter the velocity and pressure of the flow according to the Venturi effect. Second end 158 may include features configured to transition a flow of aerosol between laminar and turbulent flows to selectively remove particles based on mass from the flow. Chamber 150 may include impaction surfaces resulting in turbulent boundary effects on the flow of an aerosol. Chamber 150 may deliver an aerosol to heat exchanger 120 via second end 158.

In an embodiment, chamber 150 may include one or more thermocouples to measure the temperature of reservoir 156. A thermocouple may provide feedback to a control circuit allowing for precise temperature control. In an embodiment, chamber 150 and/or vessel 140 may be equipped with one or more airflow sensors to detect a flow of gas within chamber 150. Airflow sensors may provide feedback to a control circuit to adjust an amount of thermal energy delivered by heat source 154 proportional to a flow of gas. In an embodiment, airflow sensors may be configured to supply electrical energy to heat source 154 when and flow of gas is detected and to turn off heat source 154 when a flow of gas is not detected. In an embodiment, airflow sensors may be used to create an auto shut off safety and power feature of vaporizing device 100. In an embodiment, the airflow sensors may be or comprise pressure sensors. In an embodiment, the airflow sensors may be or comprise microphones. Microphones may be used as airflow sensors by detecting noises made by a percolation of a gas through a liquid contained by vessel 140.

In an embodiment, vaporizing device 100 may be designed to minimize contamination and thermal degradation product formation in thermally mediated reactions with vaporizing device 100 by ensuring that all surfaces and sealing surfaces exposed to a gas stream, precursor compound, or formed aerosol are inert, non-reactive, thermally stable, and do not contribute to any reaction with the precursor or aerosol. In an embodiment, various elements comprising vaporizing device 100 may be or comprise glass (e.g., borosilicate glass, fused silica, fused Quartz, etc.). In an embodiment, various elements comprising vaporizing device 100 may be or comprise plastic (e.g., high temperature, non-reactive, food safe, etc.). In an embodiment, various elements comprising vaporizing device 100 may be or comprise an inorganic non-metallic, metallic, metal alloy, or combination of the same.

The various elements comprising vaporizing device 100 (e.g., heat exchanger 120, intake 130, chamber 150, etc.) may be coupled to one another using techniques and methods compatible with the material(s) from which the various elements are manufactured. In an embodiment, various elements of vaporizing device 100 may be coupled using conically tapered joints, ball-and-socket joints (also known as spherical joints), threaded connections, hose connections, welds, adhesives, joint clips, fasteners, or other suitable means of coupling one element to another.

The various elements comprising vaporizing device 100 may be combined in alternative arrangements to produce various results. For example, intake 130 may deliver an intake gas to chamber 150 and chamber 150 may deliver an aerosol to vessel 140 and vessel 140 may deliver the aerosol to heat exchanger 120 before the aerosol exits vaporizing device 100 via first end 122.

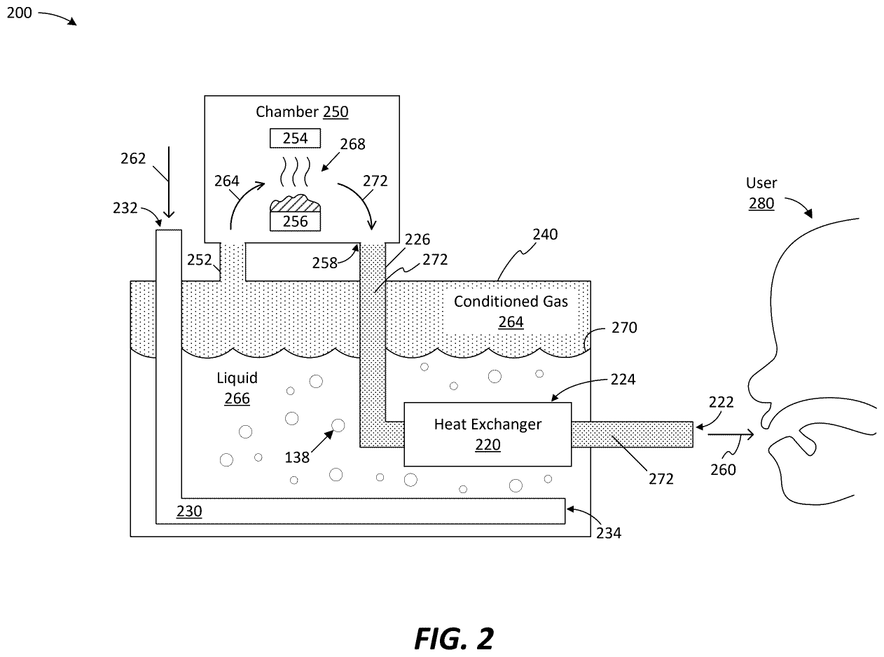

FIG. 2 is a block diagram illustrating a vaporing device. Vaporizing device 200 comprises heat exchanger 220, intake 230, vessel 240, and chamber 250. Heat exchanger 220 is an example of heat exchanger 120 of FIG. 1. Intake 230 is an example of intake 130 of FIG. 1. Vessel 240 is an example of vessel 140 of FIG. 1. Chamber 250 is an example of chamber 150 of FIG. 1.

In operation, user 280 provides suction 260 to first end 222 of heat exchanger 220 creating a flow through vaporizing device 200. Suction 260 is transferred through heat exchanger 220, chamber 250, vessel 240, and intake 230. Suction 260 draws intake gas 262 into first end 232 of intake 230. Second end 234 of intake 230 delivers intake gas 262 to liquid 266. Second end 234 may transition intake gas 262 from a laminar to a turbulent flow in liquid 266, which can increase the dwell time or transit time of intake gas 262 in liquid 266. Managing the transit time of intake gas 262 through liquid 266 may affect filtering, temperature, and humidity of conditioned gas 106.

Forcing intake gas 262 to travel or percolate through liquid 266 may create conditioned gas 264. Particles may be removed from a stream of intake gas 262 by liquid 266 as it travels through liquid 266. In an embodiment, liquid 266 may bring into solvation constituents included in intake gas 262. The humidity level or degree of saturation of intake gas may be adjusted as intake gas 262 percolates through liquid 266. The temperature of intake gas 262 may be adjusted as intake gas 262 percolates through liquid 266.

Control over a dynamic flow state (degree of percolation) of liquid 108 in vessel 140 can be achieved by adjusting the volume and velocity of intake gas 262 passing through liquid 266. Vessel 240 may include flow architecture that influences the path intake gas 262 through liquid 266. Mechanical structures along the flow path, such as heat exchanger 220, may increase the dwell time of intake gas 262 as it percolates through liquid 266. The design and placement of heat exchanger 220 within vessel 240 may be optimized to maximize interference with the flow of intake gas 262, increasing the dwell time of intake gas 262 and enhancing displacement flow dynamics. In addition, movement of intake gas 262 creates a dynamic flow of liquid around heat exchanger 220. This dynamic flow of liquid around heat exchanger 220 may improve a rate of heat transfer between liquid 266 and heat exchanger 220. Conditioned gas 264 is created when intake gas 262 passes through boundary layer 270 of liquid 266 and is contained by vessel 240.

Conditioned gas 264 is supplied by vessel 240 to chamber 250 via second end 258. Second end 258 may include a user adjustable port to mix a volume of intake gas 262 into a stream of conditioned gas 264. Second end 258 delivers a high velocity high pressure vortical flow of conditioned gas 264 near precursor composition 268 held be reservoir 256. Thermally mobilized constituents of precursor composition 268 may be entrained in the flow of conditioned gas 264. The vortical flow of conditioned gas 264 may select thermally mobilized constituents of precursor composition 268 based on mass as described above. The vortical flow of conditioned gas 264 may reduce the thermal energy required to affect a phase change or transition to aerosol of precursor composition 268 by increasing the transit time based on mass and maximizing dynamic flow mediated exposure to a heated region of chamber 250. The centrifugal effects of the vortical flow may serve to disperse precursor composition 268, which under non vortical flow absent of centrifugal force effect would pool and reach a boiling point of precursor composition 268 and resultantly bubble off a fraction of precursor composition's 268 volume as a gas phase or aerosol while the remaining volume continues to boil. This essentially boils off precursor composition 268 and subjects the mass to the required thermal energy to mobilize precursor composition 268 en bloc. However, while under a centrifugal flow mediated rotation precursor composition 268 may be dispersed across reservoir 256 in a thin layer. Thermal transfer through this thin layer of precursor composition 268 may be more efficient and faster than the en bloc heating as may be defined by Q/t=kA((T1−T2)/l). Where: Q/t may be the rate of heat transfer, k may be the thermal conductivity of the material, A may be the cross-sectional area, T1−T2 may be the temperature difference, l may be the thickness. Where the cross-sectional area may be increased and the thickness may be decreased in the centrifugal rotational flow mediated chamber. Inhalation aerosol 272 comprises thermally mobilized constituents of precursor composition 268 entrained in a flow of conditioned gas 264. Inhalation aerosol 272 passes through first end 252 of chamber 250.

The methods and processes described for normalizing inhalation aerosol 272 and reducing the thermal energy required for phase transition or aerosolization of precursor composition 268 may also reduce harmful or undesirable thermal degradation compounds. This can be framed as a method for producing a non-thermally degraded inhalation aerosol 272, preserving desirable compounds through thermal modulation. The approach may improve efficiency and safety in the delivery of thermally mobilizable compounds by generating a dynamically induced thin film of liquid precursor composition 268 and thermally mobilizing precursor composition 268 into inhalation aerosol 272. This process also enhances the transit time and mixing of thermally mobilized precursor composition 268 with conditioned gas 264. The initial formation of aerosol particles, which have a lower saturation level compared to conditioned gas 264, allows these particles to absorb moisture from the flow of conditioned gas 264. The process depends on interaction time, frequency of interactions, temperature, and pressure, driving the aerosol particle saturation toward equilibrium with conditioned gas 264. This process may effectively normalize the saturation state of the formed inhalation aerosol 272 relative to the conditioned gas 264 stream.

Second end 258 may include airflow features for control over velocity and pressure gradients for particle normalization of inhalation aerosol 272. Second end 258 may include regions of constriction and expansion that may alter the velocity and pressure of a flow of inhalation aerosol 272 according to the Venturi effect. Second end 258 may include features configured to transition a flow of inhalation aerosol 272 between laminar and turbulent flows to selectively remove particles based on mass from the flow. Second end 258 may include impaction surfaces resulting in turbulent boundary effects on the flow of inhalation aerosol 272. Chamber 250 may deliver inhalation aerosol 272 to heat exchanger 220 via second end 258.

Heat exchanger 220 may be configured to normalize a temperature difference between inhalation aerosol 272 passing through heat exchanger 220 and liquid 266 exterior to heat exchanger 220. Wall 224 forms a passageway between first end 222 and second end 226 and may be configured to physically separate inhalation aerosol 272 from liquid 266 contained by vessel 240. Wall 224 may have a consistent inner diameter allowing for laminar flow of inhalation aerosol 272 through heat exchanger 220 thereby reducing undesired impaction of aerosol particles with the interior of wall 224. As inhalation aerosol 272 flows through heat exchanger 220, inhalation aerosol 272 seeks thermal equilibrium with wall 224 and wall 224 seeks thermal equilibrium with liquid 266. A dynamic flow of liquid 266 occurring exterior to wall 224 of heat exchanger 220 may increase a rate of heat transfer between wall 224 and liquid 266. Inhalation aerosol 272 may be thermally mediated, for example cooled or heated, by heat exchanger 220. Finally, suction 260 draws inhalation aerosol 272 out of first end 222 of heat exchanger 120, which may be consumed by user 280.

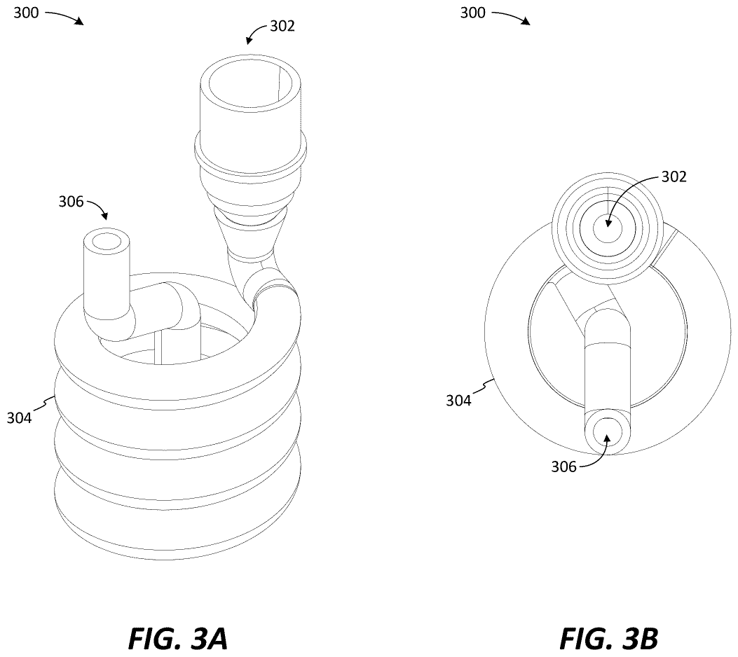

FIG. 3A illustrates an isometric view of a heat exchanger and FIG. 3B illustrates a top view of a heat exchanger. Heat exchanger 300 may be an example of heat exchanger 120 of FIG. 1 or heat exchanger 220 of FIG. 2. Heat exchanger 300 functions to normalize a temperature difference between an inhalation aerosol within heat exchanger 300 and a surrounding fluid exterior to heat exchanger 300 in communication with coil 304. Coil 304 may be immersed in a liquid ensuring effective thermal exchange between the liquid and an inhalation aerosol traversing the interior of coil 304. Coil 304, comprising both interior and exterior surfaces, physically separates an inhalation aerosol flowing through the interior of coil 304 from a fluid exterior to coil 304. Heat exchanger 300 includes coil 304 comprising a tube extending between output port 302 and input port 306. Coil 304 maintains a consistent inner diameter that facilitates laminar flow, thereby minimizing particle impaction within coil 304. When suction may be applied to output port 302, an inhalation aerosol may be drawn into heat exchanger 300 through input port 306, traversing the interior of coil 304. The temperature of coil 304 seeks thermal equilibrium with a liquid volume and dynamic flow occurring exterior to coil 304. The inhalation aerosol traveling on the interior of coil 304 also seeks to be in thermal equilibrium with coil 304 and may be thermally mediated, for example, cooled relative to the inhalation aerosol temperature when compared to the liquid temperature or heated when the same comparison may be made depending on the embodiment. In an embodiment the liquid may serve to cool heat exchanger 300. In an embodiment the liquid may serve to warm heat exchanger 300. In an embodiment, the liquid may maintain heat exchanger 300 temperature at ambient. In an embodiment, the liquid may maintain the heat exchanger 300 temperature at human physiological temperature (approximately 99 Degrees).

Output port 302 may be configured to receive suction and deliver an inhalation aerosol. In an embodiment, output port 302 may be configured to couple to a mouthpiece (not shown). In an embodiment, the mouthpiece may comprise a positionable mouthpiece where the ability to position the mouthpiece may be due to a ball and socket type of sealed joint arrangement. In an embodiment, output port 302 may comprise a taper joint.

Input port 306 may be configured to transfer suction to other elements of a vaporizing device and to receive an inhalation aerosol. In an embodiment, input port 306 may be or comprise a conically tapered joint, ball-and-socket joint (also known as a spherical joint), threaded connection, hose connection, joint clip, etc.

In an embodiment, the various elements comprising heat exchanger 300 may be or comprise glass (e.g., borosilicate glass, fused silica, fused Quartz, etc.). In an embodiment, the various elements comprising heat exchanger 300 may be or comprise plastic (e.g., high temperature, non-reactive, food safe, etc.). In an embodiment, the various elements comprising heat exchanger 300 may be or comprise an inorganic non-metallic, metallic, metal alloy, or combination of the same.

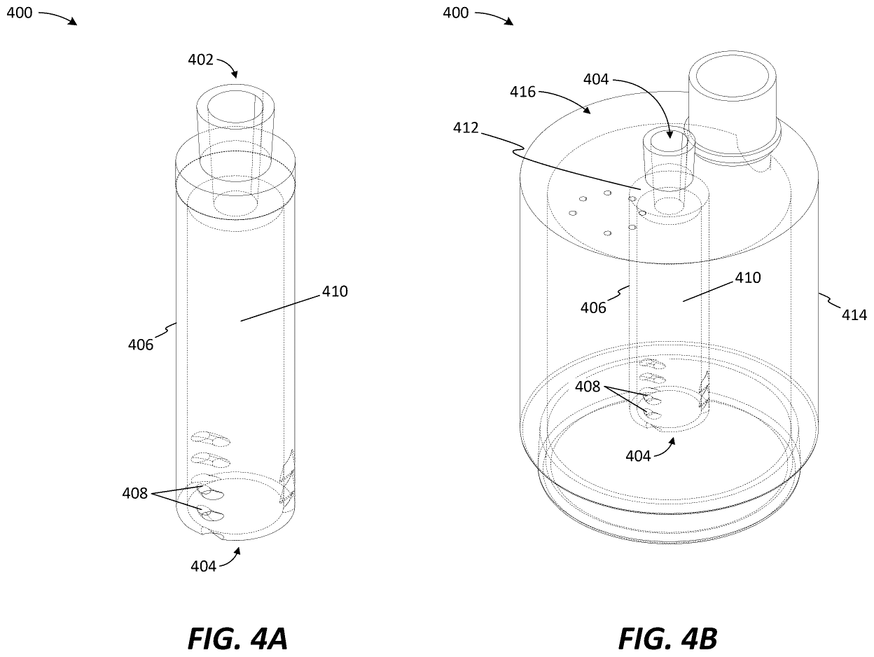

FIG. 4A illustrates an intake tube for a vaporizing device. Intake tube 400 may be an example of intake 130 of FIG. 1 and intake 230 of FIG. 2. Intake tube 400 may be configured to deliver a gas into the interior of a vessel. Intake tube 400 comprises intake port 402, delivery port 404, wall 406, radial ports 408, and intake passageway 410. Intake port 402 may be configured to receive an intake gas exterior to a vessel and deliver the intake gas below a surface to a liquid contained by the vessel to delivery port 404 and radial ports 408 via intake passageway 410 when suction may be applied to delivery port 404. In an embodiment, intake port 402 may be configured to couple to a flow control element. In an embodiment, intake port 402 may be configured to couple to a liquid tight stopper or cover. Radial ports 408 are radially disposed within wall 406 near delivery port 404. The geometry of delivery port 404, and radial ports 408, may determine an angle of attack of an intake gas delivery into a liquid volume. This geometry may transition a laminar flow on an intake gas to a turbulent flow.

In an embodiment, the various elements comprising intake tube 400 may be or comprise glass (e.g., borosilicate glass, fused silica, fused Quartz, etc.). In an embodiment, the various elements comprising intake tube 400 may be or comprise plastic (e.g., high temperature, non-reactive, food safe, etc.). In an embodiment, the various elements comprising intake tube 400 may be or comprise an inorganic non-metallic, metallic, metal alloy, or combination of the same.

FIG. 4B illustrates an intake tube in relation to a cannister for a vaporizing device. In this embodiment, intake tube 400 may be coupled to cannister 414 via interface 412. In an embodiment, interface 412 may be integral to cannister 414. For example, intake tube 400 and cannister 414 may be manufactured simultaneously in a molding operation. In an embodiment, interface 412 may comprise a weld joining intake tube 400 to cannister 414. In an embodiment, interface 412 may comprise an adhesive bonding intake tube 400 to cannister 414. In an embodiment, interface 412 may comprise threads to couple intake tube 400 to cannister 414. In this example, intake tube 400 may be centered within cannister top 416. Cannister 414 may be designed to hold fluids, with at least one fluid in a liquid state and at least one fluid in a gaseous state. Delivery port 404 and radial ports 408 are positioned within cannister 414 such that they would be submerged beneath the surface of a liquid contained within cannister 414.

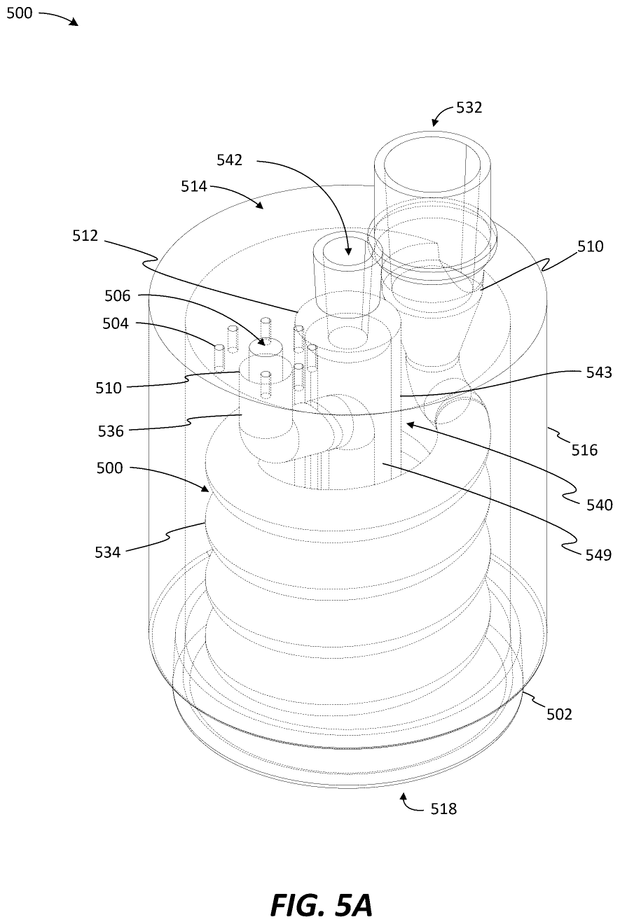

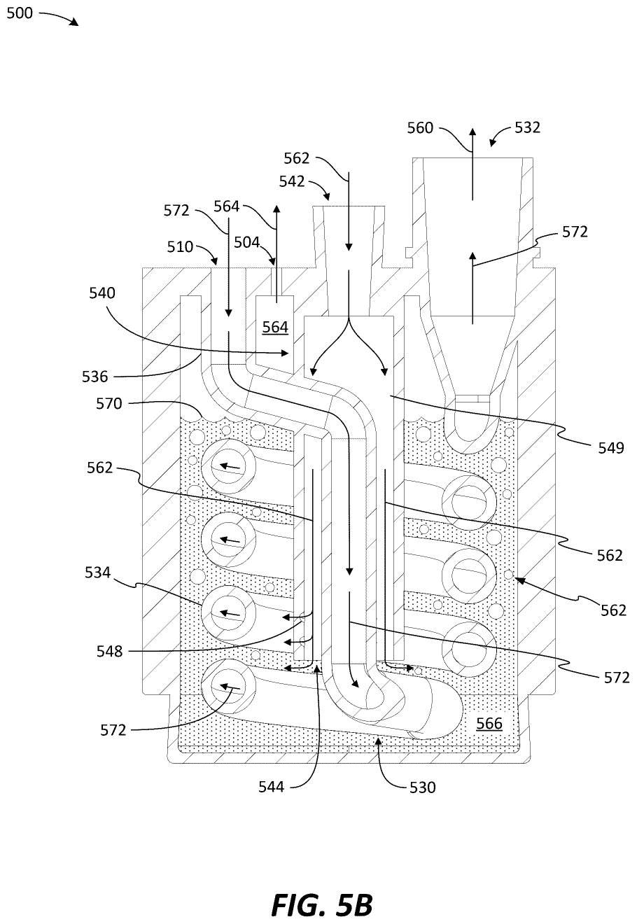

FIG. 5A illustrates a cannister assembly for a vaporizing device. Cannister assembly 500 may be an example of vessel 140 of FIG. 1 or vessel 240 of FIG. 2. Cannister assembly 500 comprises cannister 502, heat exchanger 530 and intake tube 540. Cannister 502 comprises a liquid-tight interior volume defined by cannister top 514, cannister wall 516, and cannister bottom 518. This interior volume may be partially filled with a liquid and a gas. In this example, intake tube 540 may be centered within cannister top 514 and coupled to cannister assembly 500 via interface 512. Intake port 542 may be located on the exterior of cannister assembly 500 such that intake port 542 may receive an intake gas (e.g., air) exterior to cannister 502 and deliver the intake gas to the interior of cannister 502.

Cannister assembly 500 includes suction ports 504 in cannister top 514. Suction ports 504 transfer suction to the interior of cannister 502 causing an intake gas to flow into intake port 536, through intake passageway 549, and enter cannister 502 via delivery port 544 and radial ports 548 (delivery port 544 and radial ports 548 are obstructed by coil 534 in this illustration). In addition, suction ports 504 deliver a conditioned gas to other elements of a vaporizing device. In this embodiment, cannister 502 includes a plurality of suction ports 504, however, a single suction port may be sufficient to operate cannister assembly 500. An intake gas delivered to the interior of cannister 502 via delivery port 544 and radial ports 548 may then be forced through a liquid contained by cannister 502 by suction applied to suction ports 504 thereby creating a conditioned gas. This conditioned gas may be contained above a surface of a liquid contained by cannister 502 and then exit cannister 502 via suction ports 504.

Heat exchanger 530 may be contained by cannister 502. Coil 534 may be configured to be submerged in a liquid contained by cannister 502. In this embodiment, a portion of input port 536 of heat exchanger 530 may be centered in intake passageway 549 and passes through intake tube wall 543 near cannister top 514. This configuration may serve to maximize turbulence in a liquid contained in cannister 502 by mechanically obstructing a flow of intake gas through the liquid thereby increasing dwell or transit time of the intake gas through the liquid. Output port 532 of heat exchanger 530 may be located exterior to cannister 502. An inhalation aerosol may flow through heat exchanger 530 when suction may be applied to output port 532. Suction applied to output port 532 may be transferred to vapor port 506 and then to suction ports 504 via elements described below.

Heat exchanger 530 may be coupled to cannister 502 via interface 510. In an embodiment, interface 510 may be integral to cannister 502. For example, heat exchanger 530 and cannister 502 may be manufactured simultaneously in a molding operation. In an embodiment, interface 512 may comprise a weld joining heat exchanger 530 to cannister 502. In an embodiment, interface 512 may comprise adhesive bonding heat exchanger 530 to cannister 502. In an embodiment, interface 510 may comprise a gasket.

FIG. 5B illustrates a cross-section of a cannister assembly for a vaporizing device. In operation, suction 560 may be applied to output port 532 of heat exchanger 530 creating a flow path through heat exchanger 530 and intake tube 540. While not illustrated in FIG. 5B, suction ports 504 and vapor port 506 are in fluidic communication by elements to be discussed below that allow suction 560 to be transferred throughout cannister assembly 500. Suction 560 causes intake gas 562 to enter cannister assembly 500 via intake port 542 of intake tube 540. Intake gas 562 travels through intake passageway 549 and may be delivered to liquid 566 via radial ports 548 and delivery port 544 of intake tube 540. Radial ports 548 and delivery port 544 are located beneath liquid boundary 570. Suction 560 forces intake gas 562 to travel through liquid 566. Radial ports 548 determine an angle of attack of the flow intake gas 562 through liquid 566 and may convert the flow of intake gas 562 delivered to liquid 566 from a laminar to a turbulent flow. This transition to turbulent flow of intake gas 562 may increase the transit time of intake gas 562 within liquid 566 prior to exiting liquid boundary 570. Increasing the transit time of intake gas 562 within liquid 566 may enhance conditioning of intake gas 562 by allowing more time for the humidification and temperature normalization of intake gas 562. Coil 534 creates a mechanical obstruction to the flow of intake gas 562 through liquid 566 further increasing the transit time and turbulent flow of intake gas 562 through liquid 566 to enhance comixing or comingling of intake gas 562 with liquid 566. The movement of intake gas 562 within cannister assembly 500 and around coil 534 dynamically displaces liquid 566 thereby improving heat transfer between inhalation aerosol 572, coil 534, and liquid 566. The flow of intake gas 562 through liquid 566 may facilitate liquid filtration of intake gas 562. This may serve to scrub or filter intake gas 562 of particles, or in an embodiment to scrub and bring into solvation elements included in the stream of intake gas 562. Intake gas 562 may be further conditioned by humidification of intake gas 562 as intake gas 562 travels through liquid 566. Intake gas 562 exits liquid boundary 570 and now exists as conditioned gas 564 contained within cannister 502 above liquid boundary 570. Conditioned gas 564 may then exit cannister assembly 500 through suction ports 504. Conditioned gas 564 may be entrained with a precursor composition by apparatus and means to be discussed below to form inhalation aerosol 572. For the sake of discussion, assume that conditioned gas 564 may be combined with a precursor composition to generate inhalation aerosol 572. Inhalation aerosol 572 may be drawn into heat exchanger 530 via vapor port 510. In this embodiment, coil 534 may be comprised of a tube formed into a helix having a consistent inner diameter encouraging laminar flow and thereby reducing undesired impaction of particles contained within inhalation aerosol 572 with the interior of coil 534. As inhalation aerosol 572 passes through coil 534, inhalation aerosol 572 seeks to reach thermal equilibrium with liquid 566 and may be thermally mediated. For example, inhalation aerosol 572 may be cooled by heat exchanger 530 in one embodiment, or heated in another embodiment.

In an embodiment, liquid 566 may heat coil 534. In an embodiment, liquid 566 may cool coil 534. In an embodiment, liquid 566 may maintain coil 534 temperature at ambient. In an embodiment, liquid 566 may maintain coil 534 temperature at human physiological temperature (approximately 99 Degrees). The dynamic flow of liquid 566 surrounding coil 534, caused by the passage of intake gas 562 through liquid 566, may improve heat transfer between coil 534, inhalation aerosol 572 and liquid 566. In an embodiment, liquid 566 comprises water. In an embodiment, liquid 566 may comprise a humectant such as glycol and/or adulterated glycol. In an embodiment, liquid 566 may comprise glycerol, and/or adulterated glycerol. In an embodiment, intake gas 562 may comprise air. In an embodiment, intake gas 562 may be at atmospheric pressure. In an embodiment, intake gas 562 may be above atmospheric pressure.

In an embodiment, the various elements comprising cannister assembly 500 may be or comprise glass (e.g., borosilicate glass, fused silica, fused Quartz, etc.). In an embodiment, the various elements comprising cannister assembly 500 may be or comprise plastic (e.g., high temperature, non-reactive, food safe, etc.). In an embodiment, the various elements comprising cannister assembly 500 may be or comprise an inorganic non-metallic, metallic, metal alloy, or combination of the same.

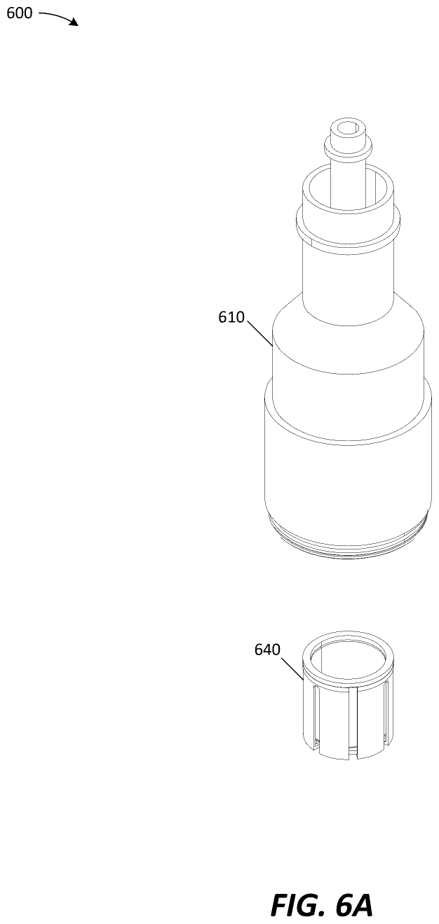

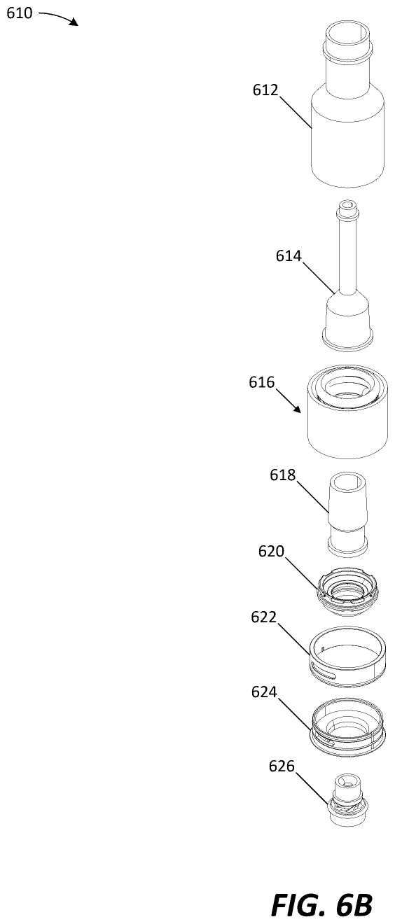

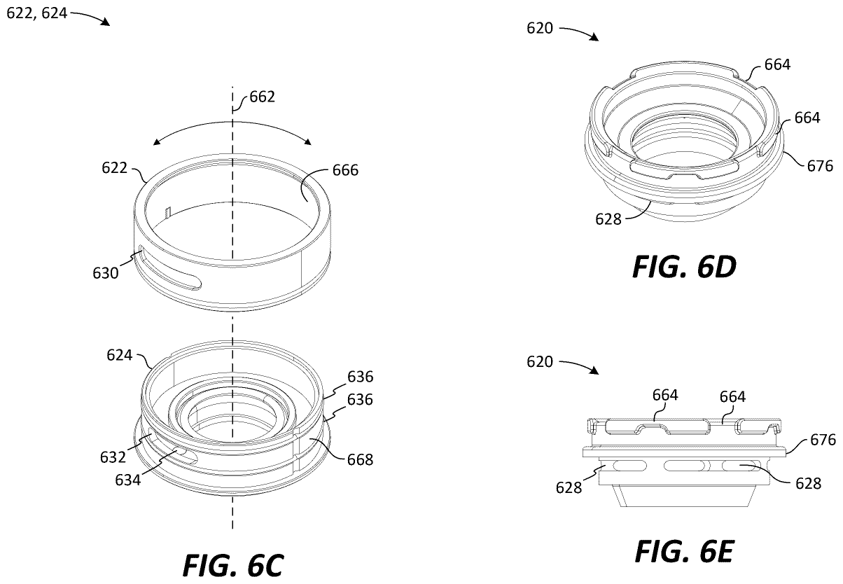

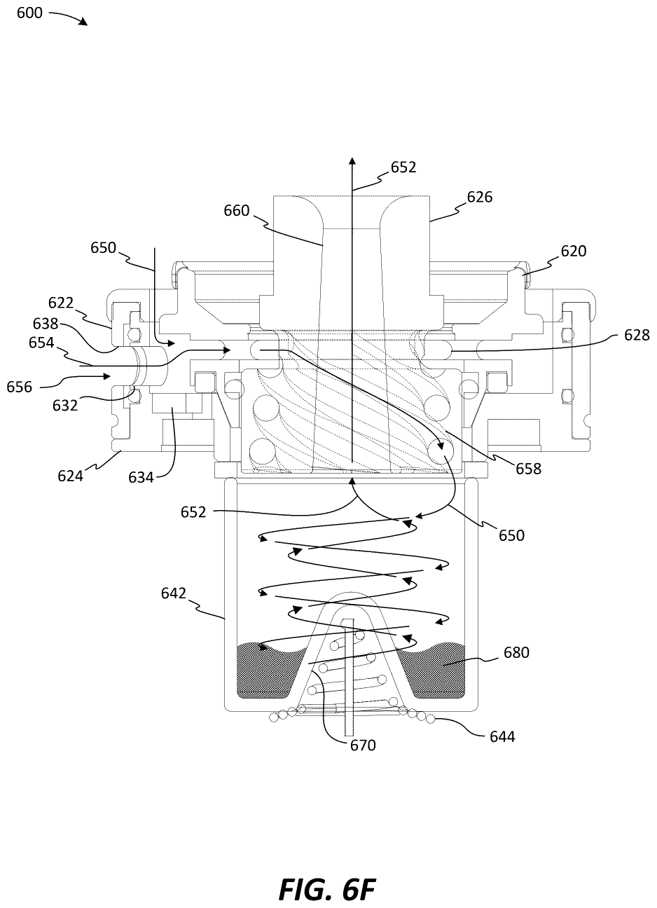

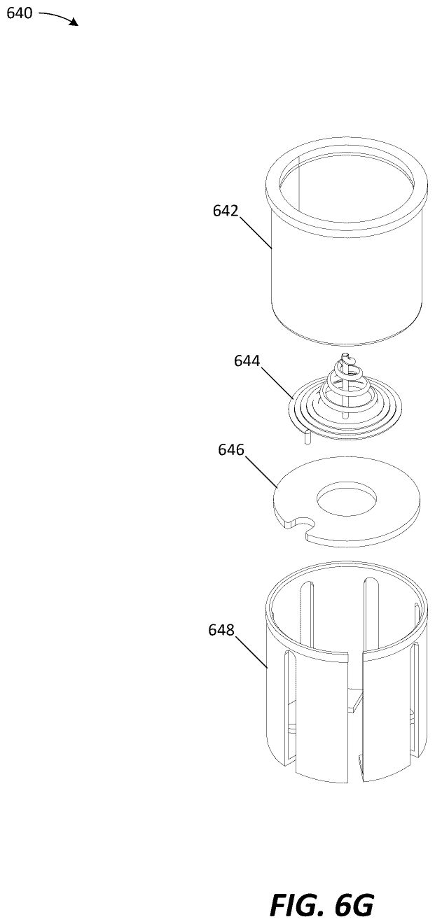

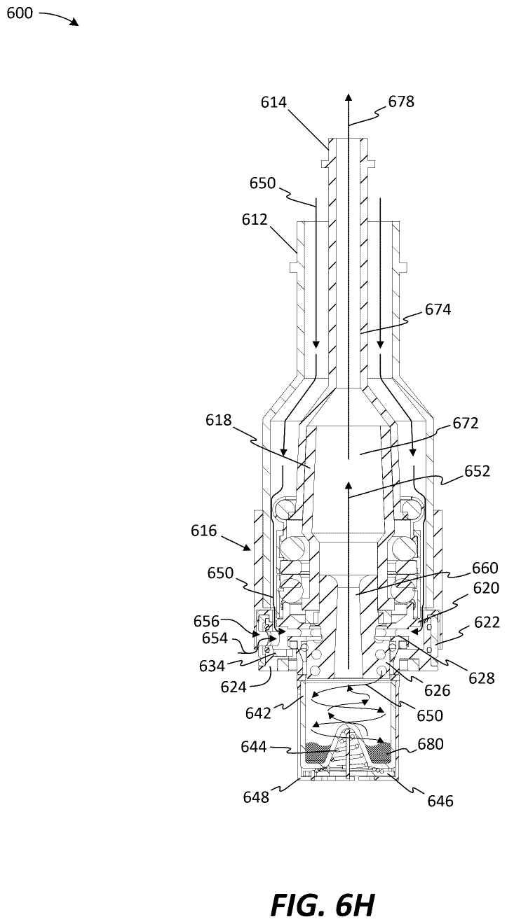

FIG. 6A illustrates a chamber assembly for a vaporizing device. Chamber assembly 600 may be an example of chamber 150 of FIG. 1 or chamber 250 of FIG. 2. Chamber assembly 600 comprises flow assembly 610 and reservoir assembly 640. In operation, flow assembly 610 and reservoir assembly 640 work together to generate an inhalation aerosol from a conditioned gas and have been divided into two sub-assemblies for the sake of discussion.

FIG. 6B illustrates an exploded view of a flow assembly for a vaporizing device. Flow assembly 610 comprises sleeve tube 612, atomizer tube 614, coupling components 616, taper joint 618, flow director 620, outer flow ring 622, inner flow ring 624, and reservoir flow director 626. Sleeve tube 612 may be configured to receive a source of suction and to deliver a conditioned gas to chamber assembly 600. In this example, atomizer tube 614 may be centered within sleeve tube 612. This arrangement may permit heat transfer between a conditioned gas flowing within sleeve tube 612 and an inhalation aerosol flowing within atomizer tube 614. The channel formed between sleeve tube 612 and atomizer tube 614 comprises a consistent cross-sectional area and encourages a laminar flow of conditioned gas within the channel. Sleeve tube 612 delivers the flow of conditioned gas to flow director 620, outer flow ring 622, and inner flow ring 624.

Atomizer tube 614 may be configured to receive and transfer suction throughout a vaporizing device and to deliver an inhalation aerosol. Atomizer tube 614 includes a first region of radial expansion and a second region of radial contraction to modify the velocity and pressure of an inhalation aerosol passing through atomizer tube 614 and may permit the selective removal of particles from the inhalation aerosol stream. Atomizer tube 614 may be centered in sleeve tube 612 and may be in thermal communication with a conditioned gas flow directed by sleeve tube 612. The conditioned gas flow within sleeve tube 612 and the inhalation aerosol flow within atomizer tube 614 will seek to be in thermal equilibrium with one another and may contribute to the selective removal of particles within the inhalation aerosol stream.

Coupling components 616 include various means to couple sleeve tube 612, atomizer tube 614, taper joint 618, flow director 620, outer flow ring 622, inner flow ring 624, and reservoir flow director 626 to one another. Coupling components 616 may comprise O-rings, magnets, seals, threads, etc.

Taper joint 618 couples atomizer tube 614 to reservoir flow director 626 and may be configured to receive suction and deliver an inhalation aerosol to atomizer tube 614. The internal geometry of taper joint 618 comprises a smooth bore truncated cone that may increase the velocity of an inhalation aerosol as the inhalation aerosol passes through taper joint 618. Reservoir flow director 626 receives suction and delivers a vortical flow of an inhalation aerosol to the end of taper joint 618 having the largest diameter. Taper joint 618 may transition the vortical flow of the inhalation aerosol to a linear laminar flow.

Flow director 620 works in combination with outer flow ring 622 and inner flow ring 624 to transfer suction to sleeve tube 612 and deliver a flow of conditioned gas to reservoir flow director 626. When assembled, flow director 620 forms a passageway between flow director 620 and the interior diameter of outer flow ring 522 and the interior diameter pf inner flow ring 624. This passageway comprises a smaller cross-section than the passageway that exists between sleeve tube 612 and atomizer tube 614 and may increase the velocity of a conditioned gas flow passing through this region. Flow director 620 includes one or more passageways to deliver a conditioned gas flow to reservoir flow director 626.

FIG. 6C illustrates an exploded view of a flow control for a vaporizing device. Flow control 622, 624 comprises two concentric rings: outer flow ring 622 and inner flow ring 624. Outer flow ring 622 includes passageway 630 through which a gas (e.g., air) may flow. Inner flow ring 624 includes passageway 632 through which a gas may flow and a plurality of annular grooves to position O-rings 636 on the outer diameter of inner flow ring 624. O-rings 636 provide friction to secure the position of outer flow ring 622 to inner flow ring 624. O-rings 36 provide an air-tight seal between outer flow ring 622 and inner flow ring 624. Outer flow ring 622 and inner flow ring 624 include complementary diameters: outer flow ring 622 includes inner diameter 666 that may be sufficiently large to accommodate outer diameter 668 of inner flow ring 624. Outer flow ring 622 can rotate about axis 662 while inner flow ring 624 remains fixed, allowing a user the ability to adjust the size of a combined passageway formed by the overlap of outer flow ring passageway 630 and inner flow ring passageway 632. This adjustable feature enables users to further condition a conditioned gas flow by selecting a desired volume of unconditioned gas to be mixed with a conditioned gas flow. Outer flow ring 622 may be rotated to fully obstruct inner flow ring passageway 632 preventing any unconditioned gas from mixing with a flow of conditioned gas.

FIG. 6D illustrates an isometric view of a flow director for a vaporizing device and 6E illustrates a side view of a flow director for a vaporizing device. Flow director 620 includes flow director passageways 628 to allow a conditioned gas to be directed from flow control 622, 624 to reservoir flow director 626. Assembly features 664 mate with coupling components 616 to position flow director 620 within chamber assembly 600. When assembled, circumference 676 and inner diameter 666 of outer flow ring 622 (see FIG. 6C) form a cylindrical gap to permit a flow of suction and conditioned gas within chamber assembly 600.

FIG. 6F illustrates a cross-section of a chamber sub-assembly for a vaporizing device. As depicted in FIG. 6F, the chamber sub-assembly comprises flow director 620, outer flow ring 622, inner flow ring 624, reservoir flow director 626, reservoir 642 and heating element 644. Reservoir flow director 626 includes a plurality of helical passageways 658 radially distributed around vapor passageway 660 centrally disposed within reservoir flow director 626. Helical passageways 658 are configured to transfer suction through a vaporizing device and to receive a flow of conditioned gas 650. The combined cross-sectional area of helical passageways 658 may be smaller than the combined cross-sectional aera of flow director passageways 628 and may cause an increase in the velocity of a flow of conditioned gas 650 as conditioned gas 650 travels through helical passageways 658. Helical passageways 658 are comprised of smooth walls and have a consistent inner diameter to encourage laminar flow of conditioned gas 650 traveling through them. Helical passageways 658 are configured to deliver a high velocity vortical flow of conditioned gas 650 into reservoir 642.

Reservoir 642 includes conical structure 670 configured to encourage and maintain the vorticial flow of conditioned gas 650 within reservoir 642 and to increase surface area of the bottom of reservoir 642. Heating element 644 provides infrared radiation to reservoir 642 and precursor composition 680 to permit the thermal mobilization (i.e., phase change or aerosolization) of constitutes comprising precursor composition 680. Conical structure 670 increases the surface area of a closed cylinder where A=πr(r+√(h²+r²) for a circular right cone and A=πr² for the closed area of a standard cylinder. Conical structure 670 increases the surface area available for exposure to an incoming conditioned gas 650 flow, as well as surface area available for heating of reservoir 642. Conical structure 670 may also serve as a companion flow director in conjunction with helical passageways 658 to preserve and maintain a vortical laminar flow that moves radially around reservoir 642. The vortical flow includes higher velocities of flow being concentrated most radial as defined by v=rω where the velocity may be directly proportional to the radial distance and therefore lower velocities are most axial to vapor passageway 660. This vortical flow may select for particle size based on corresponding particle mass as the particles moving in a rotational flow are subjected to centrifugal forces where F=mv²/r, and the force may be directly proportional to the mass. This increases the transit time of larger particles withing the rotational flow. Smaller particles may escape the rotational radial flow by moving to the axial center of reservoir 642 to be entrained in the exiting flow of aerosol 652. This method for thermally mediated particle formation couples the characteristics of rotational flow mass effects and the delivery of the requisite thermal energy needed to reduce the particle size of phase changed or aerosolized precursor composition 680 sufficiently to escape reservoir 642 and functionally serves to keep portions of precursor composition 680 having not phase changed or been transitioned into an aerosol in the region of reservoir 642 most proximal to heating element 644. In addition, this may maximize the available surface area of conical structural 670 in thermal communication with precursor composition 680 having not phase changed or aerosolized, while material that has been phase changed or transitioned to an aerosol may escape reservoir 642 via particle size and mass mediated entrainment into the escaping aerosol 652 stream out of reservoir 642. As aerosol 652 exits reservoir 642 through vapor passageway 660 the velocity may increase as vapor passageway 660 narrows.

FIG. 6G illustrates a reservoir assembly for a vaporizing device. Reservoir assembly 640 may be configured to hold and heat a precursor composition. Reservoir assembly 640 comprises reservoir 642, heating element 6544, insulator 646, and reflector 648. The geometry of reservoir 642 may be that of a cylinder open at the top end where and closed at the bottom. The bottom may be closed in such a fashion as to provide a conical structure axial to the cylinder body. This geometric structure increases the surface area available for exposure to an incoming gas flow, as well as the surface area available for heating of reservoir 642. In an embodiment, reservoir 642 may be or comprise glass (e.g., borosilicate glass, fused silica, fused Quartz, etc.) permitting transmission of infrared radiation through reservoir 642 to heat a precursor composition held by reservoir 642.

Heating element 644 provides infrared radiation to reservoir 642 to heat a precursor composition. In this example, heating element 644 comprises a wire formed into a conical spiral configured to interface with a conical structure included in the bottom of reservoir 642. Electric current may be applied to heating element 644 to produce infrared radiation. In an embodiment, heating element 644 may be or comprise stainless steel. In an embodiment, heating element 644 may be or comprise steel, aluminum, iron-chromium-aluminum alloys, titanium, nickel, copper, tungsten, nickel-chromium alloy, carbon, silicon carbide, or other materials capable of converting electrical energy into thermal energy. In an embodiment, heating element 644 may be glass encapsulated and has a gas filled, sealed vessel with a filament, resistant element, or diode encased therein and 2 or more points to establish electrical contact with said filament, resistant element, or diode. In an embodiment heating element 644 may be glass encapsulated and has a gas filled, sealed vessel with a filament, resistant element, or diode that emits visible light. In an embodiment, heating element 644 may be glass encapsulated and has a gas filled, sealed vessel with a filament, resistant element, or diode that emits non-visible light in the infrared wavelengths. In an embodiment, heating element 644 may be an inductive heater.

Insulator 646 may be configured to thermally and electrically insulate heating element 644 from other elements of a vaporizing device. Insulator 645 has a size and shape complimentary to reservoir 642. In this example, insulator 646 comprises a circular disc with holes to permit electrical connections to heating element 644 to pass through. In addition, insulator 646 electrically insulates heating element 644 from reflector 648. In an embodiment, insulator 646 may be or comprise polyether ether ketone (PEEK). In an embodiment, insulator 646 may be or comprise plastic (e.g., high temperature, non-reactive, food safe, etc.).

Reflector 648 may be configured to reflect infrared radiation emitted by heating element 644 into reservoir 642. In an embodiment, reflector may also serve to assemble heating element 644, insulator 646, and reservoir 642 by means of a friction. In an embodiment, reflector 648 may be or comprise aluminum. In an embodiment, reflector 648 may be or comprise silver, stainless steel, coated polyester film, metalized film, or some other material capable of reflecting infrared radiation.

FIG. 6H illustrates a cross-section of a chamber assembly for a vaporizing device. In operation, suction 678 applied to atomizer tube 614 creates a flow path within chamber assembly 600. Chamber assembly 600 receives conditioned gas 650 via sleeve tube 612. As conditioned gas 650 passes through coupling components 616 and between flow director 620, outer flow ring 622, and inner flow ring 624, its velocity increases due to the narrowing of the flow path. Conditioned gas 650 may be further conditioned by entraining gas 654 through combined passageway 656. Combined passageway 656 may be user adjustable. Adjusting a ratio of gas 654 to conditioned gas 650 may modify the temperature and humidity level of conditioned gas 650 and allow for precise control of aerosol 652. Combined passageway 656 may be completely closed preventing conditioned gas 650 from entraining gas 654.

In an embodiment, airflow sensor 634 may be positioned on the interior of chamber assembly 600 between combined passageway 656 and reservoir flow director 626 so that airflow sensor 634 may detect the presence of at least a flow conditioned gas 650 or a mixture of conditioned gas 650 and gas 654 when combined passageway 656 may be open.

Conditioned gas 650 then travels through flow director passageways 628 and enters helical passageways 658. Helical passageways 658 may cause the velocity of conditioned gas 650 to increase and create a vortical flow within reservoir 642. Thermally mediated constituents comprising precursor composition 680 are entrained in the vortical flow of conditioned gas 650 within reservoir 642 creating aerosol 652. Aerosol 652 exits reservoir 642 through vapor passageway 660. The narrowing truncated cone geometry of vapor passageway 660 may cause the velocity of aerosol 652 to increase as aerosol 652 enters an expansion region within taper joint 618. This expansion region causes a decrease in velocity of aerosol 652 and may introduce some turbulence and eddy currents to form near surfaces normal to the flow of aerosol 652 thereby causing particles of sufficient mass to be selectively removed from the flow of aerosol 652 by gravity. Aerosol 652 then travels into constriction region 674 of atomizer tube 614. The smooth wall and consistent cross-sectional diameter of constriction region 674 may increase the velocity and encourage laminar flow of aerosol 652.

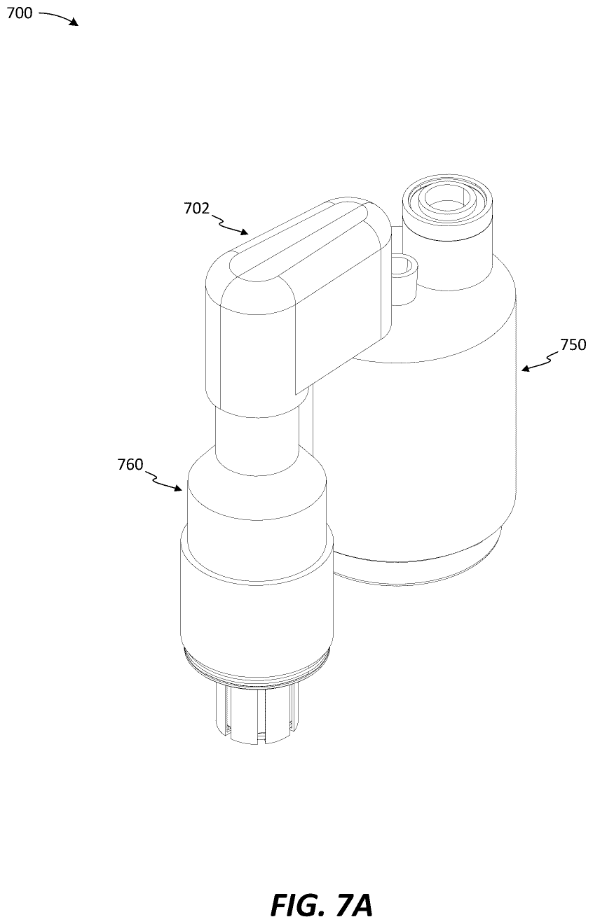

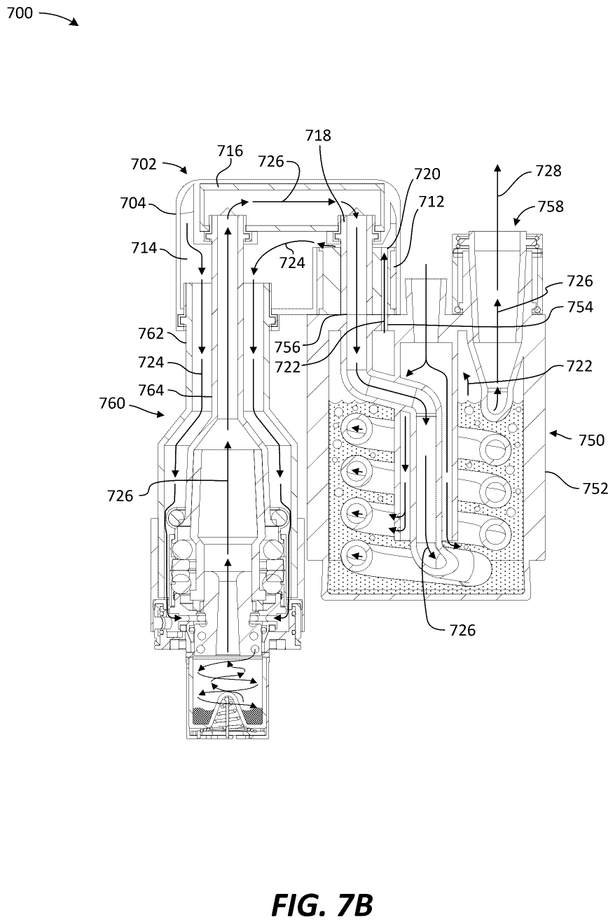

FIG. 7A illustrates an isometric view of a vaporizing device. Vaporizing device 700 comprises transfer assembly 702, cannister assembly 750, and flow assembly 760. Cannister assembly 750 may be an example of cannister assembly 500 of FIGS. 5A and 5B. Flow assembly 760 may be an example of chamber assembly 600 of FIGS. 6A-6H.

FIG. 7B illustrates a cross-section a vaporizing device. Vaporizing device 700 includes transfer assembly 702 to couple cannister assembly 750 to flow assembly 760. Transfer assembly 702 comprises housing 704, standoff 712, transfer cavity 714, aerosol transfer 716, and transfer extension 718. Housing 704 contains standoff 712 and aerosol transfer 716. Housing 704 includes transfer cavity 714 to transfer suction 728 and conditioned gas 274 between cannister assembly 750 and flow assembly 760. Housing 704 mechanically couples transfer assembly 702 to sleeve tube 762 of flow assembly 760. Standoff 712 comprises a central hole to allow transfer extension 718 to mate with vapor port 756 of cannister assembly 750. Standoff 712 includes a plurality of radially disposed suction transfer ports 720 positioned to match the locations of suction ports 754 of cannister assembly 750. Suction transfer ports 720 transfer suction 728 and conditioned gas 724 between cannister assembly 750 and flow assembly 760. Aerosol transfer 716 couples atomizer tube 764 to transfer extension 718 and transfers suction 728 and inhalation aerosol 726 between cannister assembly 750 and flow assembly 760. Transfer extension 718 couples aerosol transfer 716 to vapor port 756 of cannister assembly 750 to transfer suction 728 and inhalation aerosol between cannister assembly 750 and flow assembly 760.

In an embodiment, the various elements comprising transfer assembly 702 may be or comprise glass (e.g., borosilicate glass, fused silica, fused Quartz, etc.). In an embodiment, the various elements comprising transfer assembly 702 may be or comprise plastic (e.g., high temperature, non-reactive, food safe, etc.). In an embodiment, the various elements comprising transfer assembly 702 may be or comprise an inorganic non-metallic, metallic, metal alloy, or combination of the same.

In operation, suction 728 may be supplied to output port 758 of cannister assembly 750 initiating a flow withing vaporizing device 700. Transfer assembly 702 receives conditioned gas 724 from suction ports 754 of cannister assembly 750 at suction transfer ports 720 of standoff 712. Transfer cavity 714 delivers conditioned gas 724 to sleeve tube 762 of flow assembly 760. Cannister assembly 750 generates inhalation aerosol 726 and delivers inhalation aerosol 726 to aerosol transfer 716 of transfer assembly 702. The flow of inhalation aerosol 726 may be laminar as inhalation aerosol 726 may be received from atomizer tube 764 and may be forced to turn 90 degrees as inhalation aerosol 726 enters aerosol transfer 716. This may cause particles contained with the flow of inhalation aerosol 726 to impact the wall of aerosol transfer 716 and result in turbulent boundary effects as the flow stream impacts the normal surface. Large particles remaining in a stream of inhalation aerosol 726 may impact the normal surface or be unable to escape the boundary layer flow disturbances and be unable to remain entrained in a stream of inhalation aerosol 726. Smaller particles may remain entrained in the stream of inhalation aerosol 726, or become entrained once exiting the boundary layer turbulence in the stream of inhalation aerosol 726, further selecting for a mass selected particle range. Inhalation aerosol 726 may be then delivered to cannister assembly 750 via transfer extension 718. Transfer extension 718 may comprises a tube having a smooth, consistent inner diameter to encourage laminar flow of inhalation aerosol 726.

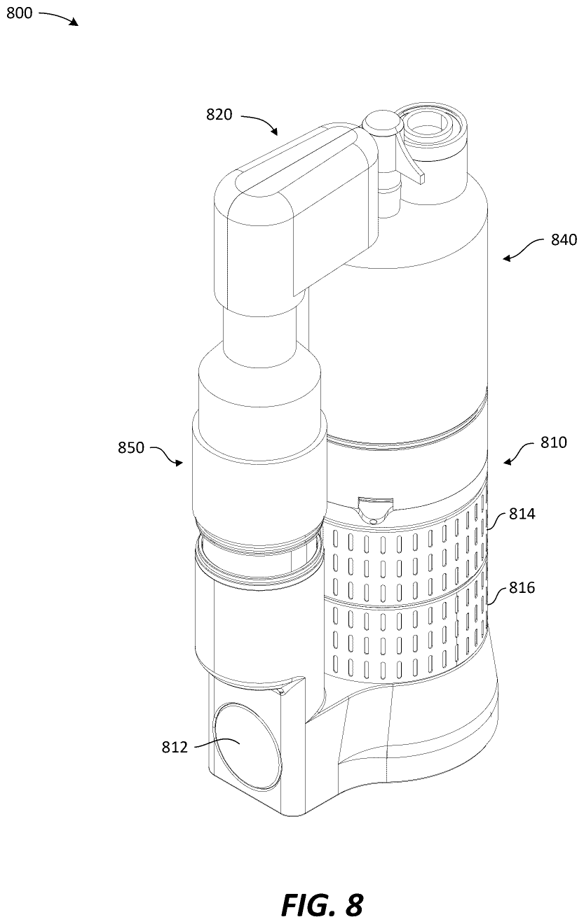

FIG. 8 is an illustration of a vaporizing device. Vaporizing device 800 comprises power component 810, transfer assembly 820, cannister assembly 840, and chamber assembly 850. Vaporizing device 800 is an example of vaporizing device 100 of FIG. 1, vaporizing device 200 of FIG. 2, or vaporizing device 700 of FIG. 7. Transfer assembly 820 may be an example of transfer assembly 702 of FIG. 7. Cannister assembly 840 may be an example of vessel 140 of FIG. 1, Vessel 240 of FIG. 2, Cannister assembly 500 of FIG. 5, or cannister assembly 750 of FIG. 7. Chamber assembly 850 may be an example of chamber 150 of FIG. 1, chamber 250 of FIG. 2, Chamber assembly 600 of FIG. 6, or Flow assembly 760 of FIG. 7.

Power component 810 includes a source of electrical energy, such as a battery, to power electrical elements comprising vaporizing device 800. Vaporizing device 800 may include airflow sensor(s), thermocouple(s), LED(s), electrical control circuits, etc. that may be receive power from power component 810. Electronic control circuitry may be included in power component 810. Activation switch 812 may receive input from a user to supply power to a heat source of vaporizing device 800. In an embodiment, activation switch 812 may initiate a power cycle upon receiving input from a user. Timer control ring 814 may rotate axially and the position of timer control ring 814 may correspond to an on time of a power cycle of vaporizing device 800. For example, rotating timer control ring 814 fully clockwise may correspond to a maximum on time while rotating timer control ring 814 fully counterclockwise may correspond to a minimum on time. Likewise, Temperature control ring 816 may rotate axially and the position of temperature control ring 816 may correspond to a temperature output by a heat source of vaporizing device 800. For example, rotating temperature control ring 816 fully clockwise may correspond to a maximum output of heat while rotating timer control ring 814 fully counterclockwise may correspond to a minimum output of heat by vaporizing device 800.

Various embodiments may comprise: Device for the production of an inhalation aerosol or ‘vapor’ is portable and modular for the thermal mobilization of solid or liquid state precursor into a gas phase or aerosol, referred to commonly as vapor such to maximize the mass transfer of said precursor to the airway of an animal via inhalation. Methods and apparatus for the control of aerosol formation using inhalation to generate a vacuum on a chamber. Methods and apparatus for constructing an aerosol generation chamber to control precursor phase state transition. Methods and apparatus for generating rotational flow in a vacuum chamber. Methods and apparatus for increasing dwell time or precursor exposure to vacuum chamber via rotational, laminar, or turbulent flow. Methods and apparatus for controlling vacuum in a thermally mediated aerosol generation chamber. Methods and apparatus for control airflow volume in a thermally mediated aerosol generation chamber. Methods and apparatus for controlling temperature in a thermally mediated aerosol generation chamber. Methods and apparatus for controlling the time duration of precursor heating in a thermally mediated aerosol generation chamber. Methods and apparatus for the loading and unloading of precursor into in a thermally mediated aerosol generation chamber. Methods and apparatus for the activation or initiation of aerosol generation cycles. Methods and apparatus for the termination or cessation of aerosol generation cycles. User interface architecture allowing for visually impaired, color blind, or elderly individuals to operate the device. Methods and apparatus for conveying visual signals to the user through the device. Methods and apparatus for generating haptic or tactile feedback in the device. Methods and apparatus for preventing accidental activation of the device. Methods and apparatus for “child proofing” device. Methods and apparatus for device storage. Methods and apparatus for the magnetic assembly of device and component, and component accessories. Methods and apparatus for increasing surface area exposed to thermal source. Methods and apparatus for increasing surface area of precursor during phase transition. Methods and apparatus for forming an all glass or inert flow path to user. Methods and apparatus for forming an all glass or inert thermally mediated aerosol generation chamber. Methods and apparatus for mating to glassware with ISO standard ground glass fittings magnetically. Methods and apparatus for device storage. Methods and apparatus of the storage of precursor materials. Methods for constructing a thermoelectric precursor storage system that is glass or otherwise inert on the surfaces exposed to the precursor. Methods and apparatus for using a thermoelectric cooler heatsink to selectively warm or heat tools for the handling of precursor. Thermoelectrically cooled precursor storage container with integrated precursor handling tools. Heating of handling tools using heat sink coupled to thermoelectric cooler. Methods and apparatus for the cleaning of device components. Methods and apparatus for producing a waterproof or sealed power module for a vaporization device. Methods and apparatus for illuminating a portable vaporization device. Methods and apparatus for the use of an OLED display with a preferred embodiment being ring or bezel shape on the power module electrode surface. Methods and apparatus for activation of modes using rotation elements with an analog to digital interface. A rotational interface that provides analog input that is directional, e.g., clockwise or counterclockwise. A rotational user interface allows for the separate and simultaneous control of power, time, and airflow (volume, velocity) in the thermally mediated aerosol generation chamber. Methods and apparatus for the leak resistant storage of device. Methods and apparatus for generating a low pressure region at the thermally mediated aerosol generation chamber exist to select for smaller particles sized for inhalation and return larger particles to the thermally mediated aerosol generation chamber. Methods and apparatus for removal and handling of a modular thermally mediated aerosol generation chamber. Methods and apparatus for the construction a modular system for the storage of precursor, handling of precursor, mobilization of solid or liquid state precursor into a vapor or gas phase “aerosol” or “vapor” for the deposition into the animal airway. Methods and apparatus for reducing the thermal degradation of precursor prior to phase transition in the thermally mediated aerosol generation chamber. Methods and apparatus for reducing oxidation degradation to precursor material prior to phase transition in the thermally mediated aerosol generation chamber. Use of a water containing element to filter the incoming air before entering the thermally mediated aerosol generation chamber. Method and apparatus for precursor material handling and storage. Precursor storage device that is airless in order to prevent/limit oxidation and resultant breakdown of precursor. Precursor storage that include normalizing feature. Precursor storage that includes means of dividing precursor into does e.g., 100 mg or 200 mg for example. Precursor storage that is orientation independent. Methods and apparatus for delivering precursor dose to vaporization chamber with thermally modulated handling tools. Methods and apparatus of delivering precursor dose to vaporization chamber with thermally modulated hands free devices. Methods and apparatus for thermally modulating precursor dosing devices, instruments and tools on isolation or in sub-assembly. Methods and apparatus for isolating thermally modulated surfaces form user interfaces. Methods and apparatus for patient/user interface with thermally modulated precursor materials. Methods and apparatus for patient/user interface with thermally modulated dosed precursor materials. Methods and apparatus for isolating doses of precursor materials for handling by patient/user. Methods and apparatus for the cleaning, sterilization, decomination, and/or storage and maintenance of a aerosol delivery device and related accessories for the production of an inhalation aerosol or vapor. Methods and apparatus for the visual indication of thermal modulation via illumination (e.g. (LED(s), OLED(s) tpe display for example) of thermal modulation of precursor or mediciciment (e.g. blue indication a cooling event, and red indicating a precursor even, with all of relevant spectrum of visible light being relevant). Methods and apparatus for the visual indication of thermal modulation via illumination (e.g. (LED(s), OLED(s) displays for example) of thermal modulation of a tool or dosing instrument or device as either a stand alone device or as part of a sub-assembly acting on a precursor or medicament (e.g. blue indication a cooling event, and red indicating a precursor even, with all of relevant spectrum of visible light being relevant). Methods and apparatus for the assembly of a complete system of devices and methods and apparatus used in conjunction with the numerous sub-assemblies allows for the completion of all required aspects of the storage, handling, dosing, and mass transfer of solid or liquid state precursor into a aerosol or vapor for the purpose of inhalation or otherwise deposition or transfer said mass to a target surface or object. Methods and apparatus for the generation of a repeatable phase transition of a precursor in a liquid or solid phase to a inhalation aerosol via methods and apparatus of thermal control, precursor storage and handling, dosing, and other variable control and mitigation methods. Methods for reducing or mitigation of precursor contamination, spoilage, degradation, loss (secondary to VOC mobilization, storage leaks, contamination etc.)

In an embodiment, a vaporizing device may be charged via a USBC passthrough port into a removable 21700 Battery. This USBC port may also need to function as a USBC to USBC port for accessories for the device.

In an embodiment, a vaporizing device user interface functions primarily using a set of two dials. One for Power Output (Power Dial) and one for Time (Timer Dial). These dials, when rotated will press a series of 4 Tactile switches to activate (two per dial) This is a safety so that the dials will need to turn a maximum amount so as to press both tactile switches to activate. Each set of two tactile switches are biased such that you cannot activate all four unless you turn both dials simultaneously. For the user to turn on the device they turn the power dial clockwise until the LED lights come on AND turn the timer dial such that a time allotment has been selected.

In an embodiment, a desired temperature ranges from 320F-700F. As the power switch is rotated clockwise the temperature will increase and as it is turned counterclockwise the temperature will decrease. In an embodiment, temperature feedback to the user may be shown via RGB on the correlating set of LED's that will be light piped through the device. For example, if a green tint is shown then the device is running closer to 320F. If a red tint is shown the device is running closer to 700F.

In an embodiment, a “timer” dial will dictate the duration of the “session”. The user will turn the timer dial clockwise to increase time (up to 2 minute) and counterclockwise to reduce time. The timer dial is feedbacked by the LED's. As the user turns the timer dial clockwise a series of LED's will light up indicating the amount of time chosen. For example, if half the time is chosen by the user half of the LED's will light up. In an embodiment, the color of the LED's may be dictated by the chosen Power Output. Once both the Power has been set and the Time Duration has been chosen the device will be ready to load with concentrate.

In an embodiment the User will be able to rotate the Glass piece at the head of the unit to allow for access to the bowl. Once product has been placed inside the bowl the user may rotate the glass piece back to the bowl effecting a seal. Once a seal has been achieved the user can inhale on the mouthpiece and ingest at whatever time duration or power output they have chosen.

In an embodiment, the device may be equipped with two pressure sensors. These are placed as such that when the user inhales on the device they will give feedback to the PCBA and power will be supplied to the bowl. When the pressure sensors are not activated the power to the bowl will shut off. The pressure sensors may also activate haptic feedback that will give the user an indication that power is being sent to the bowl via a “pulse”. In an embodiment, the device may automatically shut off and the LEDS turn off once the full time set has been reached. The user may then have to start another cycle to be able to use the product. This creates the auto shut off safety and power saving feature of the device. The device may also output one long pulse from the haptic feedback when it is shutting off. The device may be fully shut off by the user at any point by rotating either the Power Dial or the Timer Dial counterclockwise until all the LED's shut off (this may also initiate one long pulse from the haptic feedback).

In an embodiment, a thermocouple placed strategically underneath the bowl will give feedback to allow a PID to be used for precise temperature control. In an embodiment, the user may place the device in a mode (e.g., stealth mode) wherein the lights on the LED turn off by turning the timer dial in a full clockwise rotation two times. For example, the user will turn the timer dial two full clockwise rotations. Once past the two full turns the LED lights may shut off and the user may now be setting the timer. In an embodiment, the user may also receive three short “pulses” (for example) from the haptic feedback that will assure them they are in stealth mode. Timer feedback in stealth mode may be accomplished by haptic feedback. For example, one pulse for 25% of the time, two pulses for 50%, three pulses for 75%, and four pulses for 100%. When in stealth mode the power setting that the device was last set at may be the only one able to run. In an embodiment, the device may be taken out of stealth mode by turning the Timer Dial counterclockwise two full rotations. The device will indicate it is out of stealth mode by the LED's coming on and two pulses from the haptic feedback.

In an embodiment, continued blinking lights from the LED when trying to set the Power Output may indicate a short or burned-out coil wire. The device may be equipped with overcharge protection, passthrough charging so that it can be used while charging, will be CE certified and designed in a manner that should UL regulations be required in the future it could obtain such a certificate. The battery selection for incoming raw goods may match ISO 9001 standards and will be expected to have less than a 1% failure rate. All wiring and wire runs may be clean and free from pinch points and the device may be sealed such that there is no concern of galvanization.

In an embodiment, reduction and mitigation of contamination and presence of thermal degradation product formation in thermally mediated reactions with an apparatus constructed such that all surfaces, and sealing surfaces that are exposed to the input factors (gas or airflow, precursor compound, formed aerosol or aerosol intake gas mixture) are inert, non-reactive, thermally stable, and non-contributory to any reaction with the precursor or formed aerosol.

In an embodiment, reduction and mitigation of contamination and presence of reaction or cross-reaction compound formation or degradation occurring from interactions between the gas stream, precursor, and formed aerosol with non-inert parts, structures, or elements of an apparatus are intended to generate an inhalable aerosol by constructing an apparatus such that all surfaces, and sealing surfaces that are exposed to the input factors (gas or airflow, precursor compound, formed aerosol or aerosol intake gas mixture) are inert, non-reactive, thermally stable, and non-contributory to any reaction with the precursor or formed aerosol.

In an embodiment, liquid (such as water) filtration of the intake gas (in an embodiment of the intake gas is standard atmosphere) into the assembly. The primary body of the vessel may comprises a liquid tight volume. Intake gas may be forced through this volume prior to entering the intake chamber that feeds the intake gas into the vacuum chamber. This may serve to scrub or filter the intake gas of particles, or in an embodiments to scrub and bring into solvation elements in the intake gas stream.

Humidification of intake gas normalization may use water as the filtration liquid. Intake gas humidity may be normalized by transit through the water prior to entering a chamber where there is a boundary layer of the liquid to air interface. The chamber may feed the intake gas to the vacuum chamber configured such that as the volume decreases over the length of the chamber which increases the velocity of the intake gas via mass selection of the humidified gas particles due to gravity and the effects of entrainment (amongst other flow dynamics described below) in the gas stream.

In an embodiment the apparatus may utilize a humectant to control moisture content and degree of saturation of the intake gas, and example would be utilizing a liquid humectant such as vegetable based glycerol as the liquid.

Heating of the gas intake chamber that feeds intake gas into the vacuum chamber at the end most distant from the liquid volume and most proximal to the gas intake region of the vacuum chamber may normalize the temperature of the intake gas. In an embodiment, the heating of the intake gas may serve to facilitate a thermally mediated reaction in the vacuum chamber such that the heated gas serves to provide the required thermal energy for a desired reaction, process, phase change, or similar such thermally mediated or influenced event to occur.

In an embodiment, there may be a convective mobilization of compounds from a larger parent structure such as the thermal mobilization of active compounds or agents from a botanical media. In an embodiment, there may be is a mixed convective and conductive thermal mobilization of active compounds or agents from a botanical parent media. In an embodiment, there may be a mixed convective and conductive thermal mobilization of active compounds or agents from a botanical parent media for the generation of an inhalable aerosol comprised of the active agent or compounds thermally extracted from the botanical media.

In an embodiment there may be is a mixed convective and conductive thermal mobilization of active compounds or agents from a botanical parent media for the selective collection of compounds or agents from a botanical media.

In an embodiment a source of thermal energy is glass encapsulated and has a gas filled, sealed vessel with a filament, resistant element, or diode encased therein and 2 or more points to establish electrical contact with said filament, resistant element, or diode.

In an embodiment a source of thermal energy is glass encapsulated and has a gas filled, sealed vessel with a filament, resistant element, or diode that emits visible light.

In an embodiment a source of thermal energy is glass encapsulated and has a gas filled, sealed vessel with a filament, resistant element, or diode that emits non-visible light in the infrared wavelengths.

In an embodiment a source of thermal energy is an inductive heater.

In an embodiment, there may be thermal control of the condenser cooling body (which may be shown as a condenser coil with a flow length of >1 meter and an internal diameter of 2 mm over 15 turns with a height of 69 mm) by mobilization of liquid through means of mediated displacement and subsequent dynamic flow (e.g. percolation) secondary to intake gas flow passing through liquid volume contained in the vessel. In an embodiment, there may be a coil composed of a tube maximizes the surface area of the condenser body in thermal communication with the liquid reservoir and resultant thermal exchange. The above described coil condenser may result in a large (relative to a normal tube) surface area for thermal transfer to occur between the condenser and the liquid medium. Flow architecture in the apparatus may force intake airflow through the liquid column depth, the resultant passage of gas flow through the full liquid depth into a series of small orifices at the region of the chamber that feeds gas to the vacuum chamber most distal from the vacuum chamber and most proximal to the region of the full depth of the liquid volume causes displacement and flow of the liquid secondary to the displacement of liquid. This flow may be in liquid communication with the outer surface of the condenser tubing such that the outside surface area of the condenser tube is subjected to the flow of liquid moving dynamically over the outside surface of the condenser. The movement or flow of the liquid may serve to thermally regulate the condenser body as the body seeks thermal equilibrium with the mobile liquid. A cold liquid moving over the coil may better serve to cool the coil and remove heat from the coil (compared to a static non-moving liquid), and similarly a heated liquid flowing over the condenser outer surface would better serve to heat the coil. The degree of liquid flow within the vessel may be dependent on the volume and velocity of intake gas. Volume of intake in the apparatus may be mediated by intake orifice size, and velocity may be alternately or additionally mediated by the architecture of the intake airflow ports.

In an embodiment, there may be an intake gas flow port that allows for control and shape of the intake gas orifice for user control over intake gas volume and velocity entering the liquid medium.

Control over dynamic flow state (degree of percolation) of a liquid volume may be by selective control of the volume and velocity of intake gas moving through the liquid column.

In an embodiment the liquid may serve to cool the condenser.

In an embodiment the liquid may serve to heat the condenser.

In an embodiment the liquid may maintain the condenser temperature at ambient.

In an embodiment the liquid may maintain the condenser temperature at human physiological temperature (99 Degrees).

Flow architecture for control of intake gas flow through liquid media may increase transit time of intake gas through the liquid via mechanical structures along the path length that the intake gas and liquid travel while comixing or comingling of the intake gas and the liquid is occurring. The geometry of the ports or orifice (which may be shown as a pair of slots most distal on the air intake chamber from the vacuum chamber positioned 180 degrees opposing one another) may determine the angle of attack of the intake gas on the gas intake chamber that leads to the vacuum chamber. This orifice may be set at an angle normal to that of the intake gas flow, and the angle of attack of the intake gas on the orifice may be subsequently normal to, or 90 degrees to that of the intake air stream entering the and initially passing into the liquid volume. This may convert the flow at this region from linear to a turbulent non-linear, non-laminar flow. This transition to non-linear non-laminar flow may result in increasing the dwell time of the intake gas within the liquid column, generally described as the transit time of the intake gas through the liquid prior to exiting the liquid boundary into the intake gas chamber leading to the vacuum chamber. Once flow is initiated the initial fluid boundary that is encountered by the intake gas may be turbulent. This turbulence may serve to deflect the intake gas stream dynamically and increase the path length the intake air has to travel before exiting the liquid chamber and leaving the fluid boundary for the intake gas chamber that leads to the vacuum chamber. Additionally, the initial gas flow may transit around the flow disturbance that is generated from the condenser (this may be represented as a 15 turn 1 meter coil with a tube diameter of 4 mm) being located within the liquid volume such that the turbulent flow is in direct proximity of the condenser body and that the condenser body is arranged such as to further increase the disturbances and dynamic flow state by creating mechanical features and geometries (this may be shown as a coil comprised of tube) that the mixed intake gas and liquid entrained in dynamic flow encounters while transiting the liquid containing chamber. The shape of the condenser body and the location of the condenser body within the liquid chamber may be configured such as to maximize the interference of the condenser body with the mixed flow to increase dwell time of intake gas in the liquid chamber and maximize the displacement flow dynamics intended to create dynamic non-linear, non-laminar flow of liquid over the condenser surface as well as non-linear non-laminar flow of the intake gas as it transits the liquid volume.

Normalization of the temperature and saturation of intake gas may comprise maximizing flow path distance utilizing mechanical structures forcing turbulent and non-turbulent flow characteristics. The intake gas flow may exit the fluid boundary within the chamber that feeds intake gas into the vacuum chamber. The intake air chamber that feeds gas to the vacuum chamber initially may have a geometry encouraging laminar flow with no regions of expansion or constriction and maximal volume in terms of chamber capacity (i.e. the least restricted region). This may serve to normalize the flow characteristic of the turbulent high velocity flow exiting the fluid boundary. The intake gas may then be forced to impact a surface that transitions to being normal to the intake airflow flow path direction forcing a non-linear vortical rotational flow event (e.g. an eddy current). The airflow may then exit through a constriction to increase flow velocity before entering a minor expansion region that coincides with a second deflection surface to initiate and preserve another vortical rotational flow event. This sequence may repeat for a third time through a similar tertiary structure that may differ by being smaller geometrically and volumetrically in all respects serving to increase the velocity of the flow moving through the region.

The intake gas chamber that feeds the vacuum chamber may be a radial channel initially concentric without constriction or expansion, that then may transition to three regions that decrease in volume but share similar geometry to initiate and preserve vortical flow events at these regions. The decreasing volume or general construction and specific constrictions that occur along this flow length may serve to increase flow velocities both generally, as the velocity of flow nominally increases along the length of the chamber as chamber volume decreases, and regionally as the local restrictions serve to accelerate the flow at specific points of flow restriction in order to increase flow velocity prior to impaction of the flow stream onto the normal surfaces in order to increase the energy initiating and preserving the vortical flow event and increase mass mediated impaction events on the normal surfaces. In an embodiment, there may be three regions of vortical flow, in the tertiary or most proximal to the vacuum chamber, the geometries as described are the smallest of the three vortical flow chambers and have the flow with the highest velocities of the three vortical chambers.

Temperature and humidity control of intake gas may use radial heating of the higher velocity vortical flow in the tertiary chamber. This region of the chamber may be heated from the vacuum chamber heating assembly which is axial to this region.

Intake gas heating and particle normalization may use a proximal region of expansion of the intake gas prior to entering the vacuum chamber. Upon exiting the last vortical flow chamber the intake gas may enter a region of maximal constriction and laminar flow and thus maximal flow velocity this region can also be radially heated from the vacuum chamber heating assembly. The laminar flow region may terminate into a small expansion chamber that forces the gas flow path to turn 180 degrees and provides a final impaction surface normal to the flow path prior to the vacuum chamber. This region may experience turbulent and disorganized flow which increases the transit time in this region and exposure of the intake gas to the heated surfaces. The gas intake flow path may then enter into a chamber that forces a helical transit into the vacuum chamber. This final helical flow director further serves to increase the total path length traveled by the intake gas before entering the vacuum chamber.

The transit path of the intake gas can also be described by the means and methods of controlling the pressure gradients along the length of the path and correlated changes in flow velocities. Initially flow may undergo high pressure and high velocity as the intake gas stream enters the liquid vessel. This flow may become increasingly turbulent in the lower intake gas exit chamber that is at the liquid boundary. Once exiting the liquid boundary, the flow may be exposed to a region of comparatively large volume and low pressure with reduced flow velocities before encountering the first of the three flow directors. Exiting the first flow direction may be a region of constriction and higher pressure and higher velocity followed by an expansion region where pressure drops and velocity decrease. This process may repeat itself again at the previously described tertiary flow director. Then a high pressure high velocity flow region may be followed by the smallest of the described expansion chambers where velocity decreases before entering a helical constriction that increases the pressure and velocity. Once entering the chamber the volume may be comparatively larger and the pressure lower. However there is a pressure gradient within the chamber as a result of the chamber internal architecture (cylindrical with central axis (axial) conical feature) and correlating flow dynamics such that the central or axial area of the chamber that leads to the chamber exit may be lower pressure and flow velocities are lower whereas the radial region has higher flow velocities and higher pressure with a boundary region between the low pressure and high pressure flow area located above (more proximal to the chamber exit) the conical chamber feature. These pressure differentials may be relative to the flow velocities, volume and vacuum applied to the chamber resulting from the flow through the apparatus.

Heating of intake gas may be along helical flow path structure at entrance of vacuum chamber. The intake gas may transit a helical flow path that is radial to the vacuum chamber exit such that the intake gas is heated by the radial proximity. This may be shown as the intake gas flow path and the exit flow path are composed of the same tube where the intake gas travels along the outer surface of the tube and the exit gas travels on the inside of the tube. Increasing the flow path and transit time of the intake gas along this region may normalize the temperature between the intake gas and the exit flow.

Flow direction and mechanical flow deflection and flow velocity control for particle normalization as it relates to selection of particle size, particle humidification, particle velocity, and particle temperature of the gas particle stream that comprises the intake gas.

In an embodiment the above described heating of the intake gas is adiabatic.

In an embodiment the above described heating of the intake gas is isothermal.

Reduction of intake gas particle contamination by the reduction of particle contaminants into gas intake stream may be by liquid filtration and scrubbing of the intake gas flow through a turbulent liquid medium.

Process yield increases secondary to increase in uniform thermal characteristic of the intake gas flow may be as a result of the above described process as a result of the liquid filtration and scrubbing of the intake gas flow through a turbulent liquid medium and control flow characteristics resulting from the apparatus architecture.

Reduction in variability of process may result in secondary to atmospheric variability inherent to natural atmosphere, in an preferred embodiment where the atmosphere serves at the intake gas and is subject to the above described thermal energy transfer and normalization of saturated state or degree of humidification of the intake gas stream entering the vacuum chamber. This normalization process may also reduce the total amount of thermal energy required for the process when compared to the process occurring at variable atmosphere as the need for additional energy into the system to overcome or account for said atmospheric variability is mediated and the variables that dictate the calculation of required thermal energy for the process are reduced.

In an embodiment, the process may be the thermal mobilization by phase change or thermally mediated phase transition under vacuum, where user inhalation through the apparatus is the means of generating said vacuum, of a inhalable medicament(s) or agent(s) into the airway.

Decrease of thermal degradation and correlating increase in process efficiency of a gas flow and thermally mediated phase transition under vacuum by temperature and humidity normalization of intake gas may be by herein described methods and processes.

Particle size formation and selectivity of particles exiting from the vacuum chamber. Vortical rotational flow in vacuum chamber may be mediated by a structure causing the intake flow to travel a helical path at the region where the gas intake exits into the vacuum chamber. The geometry of the chamber may be that of a cylinder open at the top end where the intake gas enters through a radially positioned helices and the flow exit may be axially internal to that helical structure, and closed at the bottom. The bottom may be closed in such a fashion as to provide a conical structure axial to the cylinder body. This geometric structure increases the surface area of the closed cylinder where A=πr(r+√(h²+r²) for a circular right cone and A=πr² for the closed area of a standard cylinder. This increases the surface area available for exposure to the incoming gas flow, as well as surface area available for heating of the chamber. The structure may also serve as a companion flow director in conjunction with the helical flow director at the gas intake entrance of the vacuum chamber. This conical structure may preserve and maintain a vortical laminar flow that moves radially around the chamber with higher velocities of flow being concentrated most radial as defined by v=rω where the velocity is directly proportional to the radial distance and therefore lower velocities are most axial and thus proximal to the chamber exit. This flow may select for particle size based on corresponding particle mass as the particles moving in a rotation flow are subjected to centrifugal forces where F=mv²/r, and the force is directly proportional to the mass. This increases the transit time in the rotational flow of the heated vacuum chamber of larger particles while smaller particles can escape the rotational radial flow by moving to the axial center of the chamber and be entrained in the exit flow stream. This method for thermally mediated particle formation couples the characteristics of rotational flow mass effects and the delivery of the requisite thermal energy needed to reduce the particle size sufficiently to escape the vacuum chamber. Functionally serving to keep the precursor material (material having not phase changed or been transitioned into an aerosol) in the region of the vacuum chamber most proximal to the chamber heater assembly and maximizing the available heated surface of the chamber, namely the base region the encompasses the previously described conical structural feature, in thermal communication with the precursor, while material that has been phase changed or transitioned to an aerosol may escape the chamber via particle size and mass mediated entrainment into the escaping or exit flow stream out of the chamber.

Chamber architecture for control over pressure gradients within the chamber in combination with the application of heat along a structural region trapping precursor in a comparatively high velocity, high pressure region, may reduce the thermal energy required to effect a phase change or transition to aerosol by increasing the transit time based on mass, maximizing dynamic flow mediated exposure to heated region of chamber, and dynamic mixing or mobilization of the material mitigating static exposure to the heating assembly. The centrifugal effects of the vortical flow may serve to disperse the precursor which under non-vortical flow absent of centrifugal force effect would pool and reach its boiling point and resultantly bubbling off a fraction of its volume as a gas phase or aerosol while the remaining volume continues to boil, essential boiling off the precursor and subjecting the mass to the required thermal energy to mobilize the precursor en bloc, however while under centrifugal flow mediated rotation the precursor is dispersed across the chamber in a thin layer, thermal transfer through this thin layer is more efficient and faster than the en bloc heating as is defined by Q/t=kA((T1−T2)/l). Where: Q/t is the rate of heat transfer, k is the thermal conductivity of the material, A is the cross-sectional area, T1−T2 is the temperature difference, l is the thickness. Where the cross-sectional area is increased and the thickness is decreased in the centrifugal rotational flow mediated chamber.

This may be described as a method and process for the formation of an inhalation aerosol using centrifugal flow forms to generate a dynamic thin film of precursor material for thermal mobilization to an aerosol.

The above described methods and processes for normalization of intake gas and reduction of required thermal energy to effect a phase transition or aerosolization event may serve as methods and processes for the reduction of harmful, potentially harmful, or undesirable thermal degradation compounds occurring as byproducts of the thermally mediated process. This may also be stated as a means and method for the production of a non-thermally degraded aerosol. As thermal degradation can form unwanted compounds it can also destroy or diminish desirable compounds, as such this method and process could be stated as a method and process of the preservation of compounds for inhalation undergoing thermal modulation. This can be stated as a method and process for improved efficiency and safety in the delivery by inhalation of thermally mobilizable compounds. This can be stated as a flow mediated centrifugally induced non-static or dynamic thin film generation of a liquid precursor and thermal mobilization of said thin film precursor into an inhalable aerosol.

The exit flow (the flow stream leaving the chamber) exits through a chamber of lower pressure, effectively a smooth bore cylinder of effectively larger volume than the chamber to transition the vortical flow two a linear laminar flow, this allows for any larger particles that may have been entrained in the exit airflow to return to the chamber due to gravitational forces further selecting for an aerosol comprised of a select range of particle sizes. This region may then transition to a region of radial expansion with an impaction surface directly normal to the flow path forcing the flow to make a 90 degree turn, the large impaction surface results in turbulent boundary effects as the flow stream impact the normal surface and encounters a region radial expansion. Any large particles remaining in the entrained flow stream will impact the normal surface or be unable to escape the boundary layer flow disturbances and be unable to remain entrained in the flow stream, while the smaller particles will remain entrained in the flow stream, or become entrained once exiting the boundary layer turbulence in the exit flow stream, further selecting for a mass selected particle range.

After entering the radial expansion described above, the exit flow stream may go down a contracting region to increase the relative velocity of the flow stream. The flow stream may then encounter another impaction surface occupying a region of a radial gap such as to provide a surface normal to the flow stream for capturing larger particles by direct impaction and also to create a region of turbulent flow in conjunction with a region of expansion and subsequent lower presser and decreased velocity. This may repeat a second time. This process of increasing the flow velocity, forcing and impaction event that is corollary to a turbulent flow transition in a region of geometric expansion and correlating pressure reduction and associated reduction in flow velocity of the exit flow stream serves to select for desired particle size range but also serves to increase the transit time and mixing of generated aerosol with the carrier gas in order to allow for normalization of saturation of exit flow as the aerosol particles when initially formed will have a lower relative state of saturation than the carrier gas (the carrier gas for the purpose of this discussion is the intake gas flow that has transited through the chamber and now has formed aerosol entrained in it flow stream) as the carrier gas has comparatively low mass and high velocity, and having passed through the liquid volume has a degree of saturation (humidification) that is preserved through the transit of the vacuum chamber, the formed aerosol particles are hygroscopic and will absorb available moisture from the flow stream (this can be expressed mathematically but is beyond the scope of this description). This process has dependency on both time of interaction, and frequency of interactions amongst several other key variables including temperature and pressure such that the generated aerosol particles will seek equilibrium in the degree of particle saturation with that of the carrier gas stream. Increasing the transit time duration, frequency of interaction, changes in pressure and temperature serve to drive the aerosol particle saturation to a state of equilibrium in terms of saturation to that of the carrier gas stream. This could be stated as a normalization of the saturation state of the formed aerosol and carrier gas stream.

A method for the formation of a temperature and humidity normalized inhalation aerosol to increase fraction of active agent or compound available for delivery to the target tissue.

Following the secondary region of combined impaction, expansion, turbulence, and subsequent restriction and increased velocity and pressure, the exit stream (carrier gas and entrained aerosol) may travel down a restricted region of consistent geometry were the flow is laminar and high velocity, this leads to a constriction leading to the condenser body in which velocity further increases as the relative flow area constricts, this constriction point has an opening that is normal to the flow stream forcing the flow to turn 90 degrees in order to enter the condenser. Below this opening there may be a void in the chamber such that any condensate or droplets formed in the region above this entrance to the condenser, also being described as being the region below the vacuum chamber exit impaction plate, are trapped in this void region and are prevented from entrance into the condenser tubing, this serves to trap condensate, droplets, large particles outside the desired range and further selects for the desired particle fraction. Additionally this may serve as a region for a condensate forming in the condenser to drain.

The exit stream may enter the condenser which may have a consistent inner diameter allowing for laminar flow reducing undesired impaction of aerosol particles with the condenser wall. The exit flow may pass through the condenser and the temperature of the condenser tubing seeks thermal equilibrium with the liquid volume and dynamic flow occurring on the outer wall of the condenser, the exit flow also seeks to be in thermal equilibrium with the inner wall of the condenser flow path and is thermally mediated, for example cooled relative to the aerosol temperature when compared to the liquid temperature or heated when the same comparison is made depending on the embodiment. In an embodiment water is used as the liquid to cool the condenser and exit stream which is warmer comparative to the water.

The exit stream having been thermally mediated by a comparatively long transit through the condenser body may exit into a region of expansion with a cylindrical concave impaction surface normal to the flow path and a liquid or particle trap below the impaction surface such that any condensate, droplets or large particles are contained in this region of expansion, lower relative pressure to that of the coil, and lower relative velocity. This region of flow may be turbulent given the impact flow and boundary flow that occurs when the high velocity flow exits the condenser and impacts the cylindrical surface to mitigate undesired entrainment of larger particles, condensate, or liquid droplets in the exit stream. Serving as a point for selection of the particle size where the desired particles forming the aerosol fraction of the exit stream that are of the desired particle size and have an equilibrated state of saturation are entrained in the exit flow.

In an embodiment the chamber that follows the condenser then exits to a positionable mouthpiece where the ability to position the mouthpiece is due to a ball and socket type of sealed joint arrangement.

These methods, processes, and/or apparatus may serve as a combined method and process for the simulation of the human airway physiological dynamics in the formation (the phase change or transition processes) and generation (the particle size selection, thermal modulation, and equilibrating of the level of saturation) of an inhalable aerosol that is matched to the physiological temperature and saturation of the human airway.

These methods, processes, and/or apparatus may generate an inhalation aerosol at human physiological temperature and level of humidity or saturation in order to effect more complete delivery of an inhalation aerosol into the animal airway and mitigating irritation, inflammation, and thermal damage caused by inhalation of thermally generated inhalation aerosols.

These methods, processes, and/or apparatus may generate physiological temperature inhalation aerosols as a method to increase compliance with required inhalation topography for inhalation aerosol delivery to the airway.

A valve system may comprise of the portion of the apparatus were the flow deflector and region of radial expansion that the vacuum chamber exits to is partially or completely removable and allows for an additional point of entry for air to enter the device and allowing for purging of the channels that are past the vacuum chamber (i.e. the channels where the exit stream including the aerosol pass through, or the regions of the flow chamber that comprise all channels after the vacuum chamber.).

These methods, processes, and/or apparatus may provide for formation and delivery of an inhalable aerosol with temperature and saturation characteristics such that the temperature of the aerosol is 75-115 degrees Fahrenheit and the degree of saturation is 50-100%.

These methods, processes, and/or apparatus may provide for the formation and delivery of an aerosol that is non-irritating to the human airway due to irritation associated with desiccation (hygroscopic aerosols) or temperature of inhaled aerosols.

These methods, processes, and/or apparatus may provide the formation and delivery of an aerosol that is non-irritating to the human airway due to particle size fraction (e.g. small enough to remain entrained in the airflow through the airway and not impact the airway).

These methods, processes, and/or apparatus may provide the formation and delivery of an aerosol that is optimized for transit through the human or animal airways and deliver an aerosol to the deep lung, in an embodiment this is a deposition aerosol for the purpose of depositing a medicament or agent to the deep lung for transfer to the bloodstream or to act directly on the deep lung tissue.

In an embodiment the particle size is optimized for delivery to the oral cavity.

In an embodiment the particle size is optimized for delivery to the oral pharyngeal cavity.

In an embodiment the particle size is optimized for delivery to the upper airway.

In an embodiment the particle size is optimized for delivery to the middle airway.

In an embodiment the particle size is optimized for delivery to the nasopharyngeal airway.

In an embodiment the process is a reaction rather than a phase transition.

In an embodiment the apparatus comprises borosilicate glass.

In an embodiment the apparatus comprises fused Quartz.

In an embodiment the apparatus comprises fused silica.

In some embodiments the apparatus comprises an inorganic non-metallic, metallic, metal alloy, or combination of the same.

In an embodiment the apparatus may be modular allowing for the changing of heating assemblies and exit tube (user interface or mouthpiece) components

In an embodiment the apparatus may be powered by batteries and may be portable.

In an embodiment the vacuum chamber can be rotated from 1-15000 RPM.

In an embodiment the intake gas may be above atmospheric pressure.

Implementations discussed herein include, but are not limited to, the following examples:

Example 1: A vaporizer comprising: a heat exchanger to normalize a temperature differential between a vapor and a liquid exterior to the heat exchanger and comprising a passageway having a first end to receive suction, a second end, and a wall in communication with said liquid; a chamber to generate the vapor by entraining a precursor composition in a conditioned gas and comprising a first end configured to couple to the second end of the heat exchanger, a heat source to heat the precursor composition to a predetermined temperature, a reservoir to hold the precursor composition, and a second end; a vessel configured to contain fluids and the heat exchanger, having an aperture coupled to the second end of the chamber to deliver the conditioned gas to the chamber; and an intake to deliver a gas to the vessel and comprising a passageway having a first end exterior to the vessel to receive the gas and a second end to deliver the gas interior to the vessel disposed below a surface of a liquid contained by the vessel.

Example 2: The vaporizer of claim 1, wherein the heat source comprises an infrared radiation source.

Example 3: The vaporizer of claim 1, wherein the heat source comprises a resistive element coupled to the reservoir.

Example 4: The vaporizer of claim 1, wherein the second end of the intake may be configured to deliver the gas in the vicinity of the heat exchanger to displace the liquid near the wall of the heat exchanger thereby improving heat transfer.

Example 5: The vaporizer of claim 1, wherein the chamber further comprises internal geometry configured to selectively remove particles from the vapor by adjusting a velocity and a pressure of the aerosol.

Example 6: The vaporizer of claim 1, wherein the chamber further comprises internal geometry configured to provide a rotational flow of the conditioned gas near the precursor composition.

Example 7: The vaporizer of claim 1, wherein the chamber further comprises a gas intake.

Example 8: A flow path for a vaporizer comprising: an intake to deliver a gas below a surface of a liquid; a vessel configured to contain fluids and receive the gas delivered by the intake, having sufficient volume to contain the liquid and a conditioned gas above the surface of the liquid; a chamber to receive the conditioned gas and generate an aerosol by entraining a precursor composition in the conditioned gas; a heat exchanger disposed within the vessel to normalize a temperature differential between the liquid contained by the vessel and the aerosol comprising a passageway having a first end coupled to the chamber, a wall in communication with the liquid, and a second end disposed on exterior to the vessel to receive a suction source.

Example 9: The flow path for a vaporizer of claim 8, wherein the chamber further comprises internal geometry configured to selectively remove particles from the aerosol by adjusting a velocity and a pressure of the aerosol.

Example 10: The flow path for a vaporizer of claim 8, wherein the chamber further comprises internal geometry configured to provide a rotational flow of the conditioned gas near the precursor composition.

Example 11: The flow path for a vaporizer of claim 8, wherein the second end of the heat exchanger may be configured to receive suction from a user.

Example 12: The vaporizer of claim 8, wherein the chamber further comprises a gas intake.

Example 13: A vaporizer comprising: a vessel to contain fluids and house a heat exchanger in communication with said fluids having a sufficient volume to contain a liquid and a conditioned gas, and an aperture to deliver the conditioned gas; an intake to disburse a gas through the liquid contained by the vessel comprising a passageway having a first end exterior to the vessel and a second end interior to the vessel positioned below a surface of the liquid; a chamber to generate an aerosol by entraining a precursor composition in the conditioned gas from the vessel comprising a reservoir to hold the precursor composition, a heat source to heat the precursor composition to a predetermined temperature, a first passageway coupled to the aperture of the vessel and configured to receive the conditioned gas from the vessel and direct said conditioned gas in a vicinity of the precursor composition, a second end to deliver the aerosol to the heat exchanger; and the heat exchanger to normalize a temperature differential between the fluids contained by the vessel and the aerosol comprising a passageway having a first end coupled the second end of the chamber, a second end exterior to the vessel, and a wall in communication with the fluids contained by the vessel.

Example 14: The vaporizer of claim 13, wherein the heat source comprises an infrared radiation source.

Example 15: The vaporizer of claim 13, wherein the heat source comprises a resistive element coupled to the reservoir.

Example 16: The vaporizer of claim 13, wherein the second end of the intake may be configured to deliver the gas in the vicinity of the heat exchanger to displace the liquid near the wall of the heat exchanger thereby improving heat transfer.

Example 17. The vaporizer of claim 13, wherein the chamber further comprises internal geometry configured to selectively remove particles from the aerosol by adjusting a velocity and a pressure of the aerosol.

Example 18: The vaporizer of claim 13, wherein the chamber further comprises internal geometry configured to provide a rotational flow of the conditioned gas near the precursor composition.

The functional block diagrams, operational sequences, and flow diagrams provided in the Figures are representative of exemplary architectures, environments, and methodologies for performing novel aspects of the disclosure. While, for purposes of simplicity of explanation, methods included herein may be in the form of a functional diagram, operational sequence, or flow diagram, and may be described as a series of acts, it may be to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention may be not limited to the specific implementations described above, but only by the claims and their equivalents.

What is claimed is:

1. A vaporizer, comprising:
a heat exchanger comprising a coil having a consistent inner diameter to encourage laminar flow, the coil defining a passageway having a first end configured to receive suction, a second end, and a wall submerged in a liquid contained by a vessel, the wall thereby being in thermal communication with the liquid and configured to normalize a temperature differential between a vapor flowing in the passageway and the liquid;
a chamber to generate the vapor by entraining a precursor composition in a conditioned gas, the chamber comprising a first end configured to couple to the second end of the heat exchanger, a heat source to heat the precursor composition to a predetermined temperature, a reservoir to hold the precursor composition, and a second end;
a vessel configured to contain fluids and the heat exchanger, the vessel having an aperture coupled to the second end of the chamber to deliver the conditioned gas to the chamber;
an intake to deliver a gas to the vessel, the intake comprising a passageway having a first passageway end exterior to the vessel to receive the gas and a second passageway end positioned below a surface of the liquid contained by the vessel, wherein the second passageway end includes radially disposed ports configured to deliver the gas in a vicinity of a wall of the coil to displace the liquid near the wall and increase local turbulence to enhance heat transfer; and
wherein the chamber further comprises radially distributed helical passageways and a conical reservoir bottom configured to impart a vortical laminar flow and an atomizer tube having constriction and expansion regions to selectively remove particles by velocity and pressure transitions.

2. The vaporizer of claim 1, wherein the heat source comprises an infrared radiation source.

3. The vaporizer of claim 1, wherein the heat source comprises a resistive element coupled to the reservoir.

4. The vaporizer of claim 1, wherein the second end of the intake is configured to deliver the gas in the vicinity of the heat exchanger to displace the liquid near the wall of the heat exchanger thereby facilitating heat transfer from the heat exchanger.

5. The vaporizer of claim 1, wherein the chamber further comprises internal geometry configured to selectively remove particles from the vapor by adjusting a velocity and a pressure of the vapor.

6. The vaporizer of claim 1, wherein the chamber further comprises internal geometry configured to provide a rotational flow of the conditioned gas near the precursor composition.

7. The vaporizer of claim 1, wherein the chamber further comprises a gas intake.

8. A vaporizer, comprising:
a vessel to contain fluids and house a heat exchanger in communication with said fluids having a sufficient volume to contain a liquid and a conditioned gas, and an aperture to deliver the conditioned gas;
an intake to disburse a gas through the liquid contained by the vessel comprising a passageway having a first end exterior to the vessel and a second end interior to the vessel positioned below a surface of the liquid;
a chamber to generate an aerosol by entraining a precursor composition in the conditioned gas from the vessel comprising a reservoir to hold the precursor composition, a heat source to heat the precursor composition to a predetermined temperature, a first passageway coupled to the aperture of the vessel and configured to receive the conditioned gas from the vessel and direct said conditioned gas in a vicinity of the precursor composition, a second end to deliver the aerosol to the heat exchanger; and the heat exchanger to normalize a temperature differential between the fluids contained by the vessel and the aerosol comprising a passageway having a first passageway end coupled to the chamber, a second passageway end exterior to the vessel, and a wall in communication with the fluids contained by the vessel;
wherein the chamber comprises radially distributed helical passageways and a conical reservoir bottom configured to impart vortical laminar flow; and
wherein the heat exchanger comprises a submerged coil having a consistent inner diameter to encourage laminar flow of the aerosol.

9. The vaporizer of claim 8, wherein the heat source comprises an infrared radiation source.

10. The vaporizer of claim 8, wherein the heat source comprises a resistive element coupled to the reservoir.

11. The vaporizer of claim 8, wherein the second end of the intake is configured to deliver the gas in the vicinity of the heat exchanger to displace the liquid near the wall of the heat exchanger thereby improving heat transfer.

12. The vaporizer of claim 8, wherein the chamber further comprises internal geometry configured to selectively remove particles from the aerosol by adjusting a velocity and a pressure of the aerosol.

13. The vaporizer of claim 8, wherein the chamber further comprises internal geometry configured to provide a rotational flow of the conditioned gas near the precursor composition.

14. A vaporizer, comprising:
a vessel containing a liquid and headspace of conditioned gas, an intake having a first end exterior to the vessel and a second end positioned below a surface of the liquid to percolate gas through the liquid;
a chamber comprising a glass reservoir configured to receive a precursor composition;
a flow director having radially distributed helical passageways to impart vortical laminar flow near the precursor composition;
an infrared radiation source configured to radiantly heat the precursor composition through the glass reservoir to generate a vapor entrained in the conditioned gas;
a heat exchanger comprising a submerged coil having a consistent inner diameter and a wall in thermal communication with the liquid configured to normalize a temperature differential between the vapor and the liquid, the submerged coil defining a passageway having a first passageway end coupled to the chamber and a second passageway end disposed on an exterior of the vessel to receive a suction source; and
an intake second end including radially disposed ports positioned in a vicinity of a wall of the submerged coil to displace liquid near the wall and increase local turbulence to enhance heat transfer.

15. The vaporizer of claim 14, wherein the infrared radiation source emits IR directed by a reflector toward the glass reservoir.

16. The vaporizer of claim 14, wherein the glass reservoir comprises borosilicate glass, fused silica, or fused quartz.

17. The vaporizer of claim 14, further comprising a thermocouple operably coupled to a controller implementing PID control of the infrared radiation source to maintain a predetermined temperature profile.

18. The vaporizer of claim 14, further comprising an airflow sensor configured to energize the infrared radiation source in response to detected flow of conditioned gas and to deactivate the infrared radiation source in absence of flow.

19. The vaporizer of claim 14, wherein an atomizer tube downstream of the glass reservoir comprises constriction and expansion regions configured to selectively remove particles via changes in velocity and pressure.

20. The vaporizer of claim 14, wherein the vapor when delivered at a mouthpiece has a temperature of 75° F. to 115° F. and a degree of saturation of 50% to 100%.

21. A vaporizer, comprising:
a vessel containing a liquid and headspace of conditioned gas, an intake having a first end exterior to the vessel and a second end positioned below a surface of the liquid to percolate gas through the liquid;
a chamber comprising a reservoir configured to receive a precursor composition;
a flow director having radially distributed helical passageways to impart vortical laminar flow near the precursor composition;
a resistive heating element formed as a conical spiral coupled to the reservoir to conductively heat the precursor composition to generate a vapor entrained in the conditioned gas;
a heat exchanger comprising a submerged coil having a consistent inner diameter and a wall in thermal communication with the liquid configured to normalize a temperature differential between the entrained vapor and the liquid, the submerged coil defining a passageway having a first passageway end coupled to the chamber and a second passageway end disposed on an exterior of the vessel to receive a suction source; and
an intake second end including radially disposed ports positioned in a vicinity of a wall of the submerged coil to displace liquid near the wall and increase local turbulence to enhance heat transfer.

22. The vaporizer of claim 21, wherein the resistive heating element comprises stainless steel, iron-chromium-aluminum alloy, nickel-chromium alloy, tungsten, silicon carbide, or carbon.

23. The vaporizer of claim 21, wherein the reservoir comprises glass and a conical spiral heater that is nested adjacent a conical bottom of the reservoir.

24. The vaporizer of claim 21, further comprising a controller implementing PID control using a thermocouple proximate the reservoir to regulate power to the resistive heating element.

25. The vaporizer of claim 21, further comprising an airflow sensor configured to energize the resistive heating element in response to detected flow of conditioned gas and to deactivate the element in absence of flow.

26. The vaporizer of claim 21, wherein an atomizer tube downstream of the reservoir comprises a laminar constriction region followed by an expansion region forming turbulence and boundary effects to selectively remove larger-mass particles.

27. The vaporizer of claim 21, wherein the vapor when delivered at a mouthpiece has a temperature of 75° F. to 115° F. and a degree of saturation of 50% to 100%.
